(19) United States
(12) Patent Application Publication
(10) Pub. No.: US 2023/0117830 A1
(43) Pub. Date: Apr. 20, 2023

(54) COMPLEXES OF N-HETEROCYCLIC CARBENES FOR TRANSITION METAL CATALYSIS

(71) Applicant: Rutgers, The State University of New Jersey, New Brunswick, NJ (US)

(72) Inventors: Michal Szostak, Newark, NJ (US); Shicheng Shi, Newark, NJ (US)

(21) Appl. No.: 17/791,684

(22) PCT Filed: Jan. 8, 2021
(86) PCT No.: PCT/US2021/012735

§ 371 Date: Jul. 8, 2022

Related U.S. Application Data
(60) Provisional application No. 62/958,583, filed on Jan. 8, 2020.

(51) Int. Cl. B01J 31/22; B01J 31/18; C07F 15/00

(52) U.S. Cl. CPC B01J 31/2273; B01J 31/181; C07F 15/006; B01J 2531/824; B01J 2231/4211; B01J 2231/4283

(57) ABSTRACT

The present disclosure provides, in part, a new class of highly active Pd(II)-NHC complexes bearing anilines as throw-away ligands. These catalysts are well-defined, air- and moisture-stable, and can be easily purified by chromatographic techniques. High activity and generality has been exemplified in the Suzuki-Miyaura cross-coupling by C—N, C—O and C—Cl cleavage. Facile syntheses of these catalysts is also described.

### CROSS-REFERENCE TO RELATED APPLICATION

This application claims priority to U.S. Provisional Patent Application Ser. No. 62/958,583 entitled “COMPLEXES OF N-HETEROCYCLIC CARBENES FOR TRANSITION METAL CATALYSIS,” filed Jan. 8, 2020, the disclosure of which is incorporated herein by reference in its entirety.

### STATEMENT REGARDING FEDERALLY SPONSORED RESEARCH

This invention was made with government support under CHE1650766 awarded by the National Science Foundation and under GM133326 awarded by the National Institutes of Health. The government has certain rights in this invention.

### BACKGROUND

Palladium-catalyzed cross-coupling reactions have revolutionized the synthesis of small molecules and are among the most important methods for the construction of diverse chemicals. In particular, the recent years have witnessed the emergence of well-defined Pd(II) precatalysts, which allow one to use the optimal 1:1 Pd to ligand ratio in operationally-convenient protocols. A number of these precatalysts, including Nolan's [Pd(NHC)(allyl)Cl]and [Pd(NHC)(cin)Cl] complexes, Organ's Pd-PEPPSI systems, Hazari's [Pd(NHC)(ind)Cl]catalystsor Buchwald's G1-G4 palladacycles are now commercially available, enabling straightforward application and reaction optimization by the end-users.

Originally designed as a complement to phosphines, NHCs (NHC=N-heterocyclic carbenes) have shown significant advantages as ancillary ligands in Pd-catalysis, including strong σ-donation and steric tuning around the metal center. Stabilization of palladium by the amine-type nitrogen is a key feature of Nolan's and Buchwald's palladacycles. As ideal catalyst design criteria, the throw-away ligand should be easily removed during the activation step to yield the active monoligated Pd(0) complex, while its re-association could stabilize the active metal species, leading to a longer catalyst lifetime.

There is thus a need in the art for novel complexes that can be used as catalysts in cross-coupling reactions. The present invention addresses this need.

### BRIEF SUMMARY OF THE INVENTION

In various embodiments, the disclosure provides a compound of Formula I, or a salt or solvate thereof:

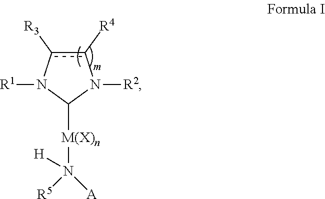

wherein:

[symbol] is a single or double bond;

R¹ and R² are each independently C₃₋₁₀ cycloalkyl, aryl, or heteroaryl, each of which is optionally substituted by at least one group selected from the group consisting of halogen, OR, SiR₃, OSiR₃, OSiR₃, OSi(OR)₃, BR₃, BR₂, B(OR)₃, B(OR)₂, CN, CF₃, OCF₃, SO₂R, SO₂N(R)₂, SO₃R, C(O)R, NR₂, N(R)SO₂R, N(R)SO₂N(R)₂, (CH₂)₀₋₂N(R)C(O)R, (CH₂)₀₋₂N(R)N(R)₂, N(R)C(O)OR, C₁₋₁₂ alkyl, C₁₋₁₂ heteroalkyl, OC₁₋₁₂ alkyl, C₃₋₁₂ cycloalkyl, C₆₋₁₀ aryl, and C₆₋₁₀ heteroaryl;

R³ and R⁴ are each independently hydrogen, optionally substituted C₃₋₁₀ cycloalkyl, optionally substituted aryl, optionally substituted heteroaryl, C₁₋₁₂ alkyl, or OC₁₋₁₂ alkyl, wherein the optional substitution comprises at least one group selected from the group consisting of halogen, OR, SiR₃, OSiR₃, OSiR₃, OSi(OR)₃, BR₃, BR₂, B(OR)₃, B(OR)₂, CN, CF₃, OCF₃, SO₂R, SO₂N(R)₂, SO₃R, C(O)R, NR₂, N(R)SO₂R, N(R)SO₂N(R)₂, (CH₂)₀₋₂N(R)C(O)R, (CH₂)₀₋₂N(R)N(R)₂, N(R)C(O)OR, C₁₋₁₂ alkyl, C₁₋₁₂ heteroalkyl, OC₁₋₁₂ alkyl, C₃₋₁₂ cycloalkyl, C₆₋₁₀ aryl, and C₆₋₁₀ heteroaryl; or

R³ and R⁴ taken together with the ring to which they are attached are used to form a C₄₋₂₀ cycloalkyl, C₆₋₂₀ aryl, or C₆₋₂₀ heteroaryl, each of which is optionally substituted by at least one group selected from the group consisting of halogen, OR, SiR₃, OSiR₃, OSiR₃, OSi(OR)₃, BR₃, BR₂, B(OR)₃, B(OR)₂, CN, CF₃, OCF₃, SO₂R, SO₂N(R)₂, SO₃R, C(O)R, NR₂, N(R)SO₂R, N(R)SO₂N(R)₂, (CH₂)₀₋₂N(R)C(O)R, (CH₂)₀₋₂N(R)N(R)₂, N(R)C(O)OR, C₁₋₁₂ alkyl, C₁₋₁₂ heteroalkyl, OC₁₋₁₂ alkyl, C₃₋₁₂ cycloalkyl, C₆₋₁₀ aryl, and C₆₋₁₀ heteroaryl;

R⁵ is H or optionally substituted C₁₋₃ alkyl;

M is a transition metal;

X is a counter anion;

A is an aryl or heteroaryl optionally substituted by at least one group selected from the group consisting of halogen, OR, SiR₃, OSiR₃, OSiR₃, OSi(OR)₃, BR₃, BR₂, B(OR)₃, B(OR)₂, CN, CF₃, OCF₃, SO₂R, SO₂N(R)₂, SO₃R, C(O)R, NR₂, N(R)SO₂R, N(R)SO₂N(R)₂, (CH₂)₀₋₂N(R)C(O)R, (CH₂)₀₋₂N(R)N(R)₂, N(R)C(O)OR, C₁₋₁₂ alkyl, C₁₋₁₂ heteroalkyl, OC₁₋₁₂ alkyl, C₃₋₁₂ cycloalkyl, C₆₋₁₀ aryl, and C₆₋₁₀ heteroaryl;

R is independently at each occurrence hydrogen or C₁₋₁₀ alkyl;

m is 1, 2, or 3; and

n is 1, 2, 3, or 4.

In various embodiments, a method of making the compound of Formula I, or a salt, solvate, geometric isomer, or stereoisomer thereof, is provided. The method includes contacting a compound with the structure

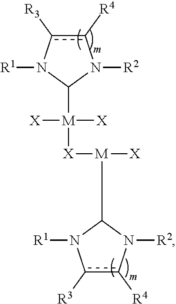

or a salt, solvate, geometric isomer, or stereoisomer thereof, with a compound with the structure of

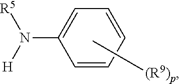

or a salt, solvate, geometric isomer, or stereoisomer thereof, in a solvent to form a compound of Formula I, or a salt, solvate, geometric isomer, or stereoisomer thereof, wherein each R⁹ is independently selected from the group consisting of hydrogen halogen, OR, SiR₃, OSiR₃, OSiR₃, OSi(OR)₃, BR₃, BR₂, B(OR)₃, B(OR)₂, CN, CF₃, OCF₃, SO₂R, SO₂N(R)₂, SO₃R, C(O)R, NR₂, N(R)SO₂R, N(R)SO₂N(R)₂, (CH₂)₀₋₂N(R)C(O)R, (CH₂)₀₋₂N(R)N(R)₂, N(R)C(O)OR, C₁₋₁₂ alkyl, C₁₋₁₂ heteroalkyl, OC₁₋₁₂ alkyl, C₃₋₁₂ cycloalkyl, C₆₋₁₀ aryl, and C₆₋₁₀ heteroaryl, and wherein p is 0, 1, 2, 3, 4, or 5.

Another method of making the compound of Formula I, or a salt, solvate, geometric isomer, or stereoisomer thereof, includes in some embodiments contacting a compound of Formula I-SM, or a salt, solvate, geometric isomer, or stereoisomer thereof:

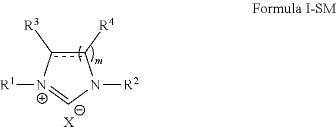

with a compound of formula MX₂(A-N(H)(R⁵))₂ in a solvent to form the compound of Formula I, or a salt, solvate, geometric isomer, or stereoisomer thereof. This reaction is, in some embodiments, performed in the presence of a base. The compound of Formula I-SM can be a stable salt of any of the NHC moieties described herein.

### BRIEF DESCRIPTION OF THE FIGURES

The drawings illustrate generally, by way of example, but not by way of limitation, various embodiments of the present application.

FIG. 1 shows structures of well-defined Pd(II) precatalysts with different throw-away ligands.

FIG. 2 shows the X-ray crystal structure of complex 6a (a) and 7a (b). Two views: front (top); side (bottom). Hydrogen atoms have been omitted for clarity except the atoms in the NHC backbone and the ArNH₂ moiety. Selected bond lengths [Å] and angles [°] (6a): Pd1-C1, 1.970(3); Pd1-N3, 2.109(2); Pd1-Cl1, 2.2997(9); Pd1-C12, 2.2990(9); C1-N1, 1.354(3); C1-N2, 1.358(3); C1-Pd1-N3, 175.5(1); N3-Pd1-Cl1, 87.59(6); N3-Pd1-Cl2, 90.51(6); C1-Pd1-C12, 90.54(8); N1-C1-N2, 105.3(2); N1-C1-Pd1, 124.2(2); N2-C1-Pd1, 130.4(2). For selected bond lengths [Å] and angles [°] of (7a).

FIG. 3 shows the topographical steric maps of [(IPr)PdCl₂(AN)] (6a) and [(SIPr)PdCl₂(AN)] (7a) showing % V_{bur} per quadrant.

FIGS. 4A-4B show the X-ray crystal structure of IPr^{#}-PEPPSI, [Pd(IPr^{#})(3-Cl-py)Cl₂] in front (FIG. 4A) and side (FIG. 4B) views.

### DETAILED DESCRIPTION OF THE INVENTION

Described herein is the synthesis, characterization, and reactivity of [(NHC)PdCl₂(aniline)] complexes which meet the criteria for an ideal catalyst. In certain non-limiting embodiments, unexpected features the catalysts herein include well-defined, air- and moisture-stable stability, and high activity in the Suzuki-Miyaura cross-coupling of amides by N—C(O) activation as well as in the Suzuki-Miyaura cross-coupling of esters and aryl chlorides and Buchwald-Hartwig amination. The compounds herein use broadly available anilines as throw-away ligands for well-defined Pd(II)-NHC catalysis. The availability of various aniline scaffolds, including with structural and electronic diversity, offers advantages in the design and fine-tuning of challenging cross-coupling reactions.

Reference will now be made in detail to certain embodiments of the disclosed subject matter, examples of which are illustrated in part in the accompanying drawings. While the disclosed subject matter will be described in conjunction with the enumerated claims, it will be understood that the exemplified subject matter is not intended to limit the claims to the disclosed subject matter.

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A and B” or “at least one of A or B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section. All publications, patents, and patent documents referred to in this document are incorporated by reference herein in their entirety, as though individually incorporated by reference.

In the methods described herein, the acts can be carried out in any order, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

### Definitions

The term “about” as used herein can allow for a degree of variability in a value or range, for example, within 10%, within 5%, or within 1% of a stated value or of a stated limit of a range, and includes the exact stated value or range.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more, or 100%. The term “substantially free of” as used herein can mean having none or having a trivial amount of, such that the amount of material present does not affect the material properties of the composition including the material, such that the composition is about 0 wt % to about 5 wt % of the material, or about 0 wt % to about 1 wt %, or about 5 wt % or less, or less than, equal to, or greater than about 4.5 wt %, 4, 3.5, 3, 2.5, 2, 1.5, 1, 0.9, 0.8, 0.7, 0.6, 0.5, 0.4, 0.3, 0.2, 0.1, 0.01, or about 0.001 wt % or less. The term “substantially free of” can mean having a trivial amount of, such that a composition is about 0 wt % to about 5 wt % of the material, or about 0 wt % to about 1 wt %, or about 5 wt % or less, or less than, equal to, or greater than about 4.5 wt %, 4, 3.5, 3, 2.5, 2, 1.5, 1, 0.9, 0.8, 0.7, 0.6, 0.5, 0.4, 0.3, 0.2, 0.1, 0.01, or about 0.001 wt % or less, or about 0 wt %.

The term “organic group” as used herein refers to any carbon-containing functional group. Examples can include an oxygen-containing group such as an alkoxy group, aryloxy group, aralkyloxy group, oxo(carbonyl) group; a carboxyl group including a carboxylic acid, carboxylate, and a carboxylate ester; a sulfur-containing group such as an alkyl and aryl sulfide group; and other heteroatom-containing groups. Non-limiting examples of organic groups include OR, OOR, OC(O)N(R)₂, CN, CF₃, OCF₃, R, C(O), methylenedioxy, ethylenedioxy, N(R)₂, SR, SOR, SO₂R, SO₂N(R)₂, SO₃R, C(O)R, C(O)C(O)R, C(O)CH₂C(O)R, C(S)R, C(O)OR, OC(O)R, C(O)N(R)₂, OC(O)N(R)₂, C(S)N(R)₂, (CH₂)₀₋₂N(R)C(O)R, (CH₂)₀₋₂N(R)N(R)₂, N(R)N(R)C(O)R, N(R)N(R)C(O)OR, N(R)N(R)CON(R)₂, N(R)SO₂R, N(R)SO₂N(R)₂, N(R)C(O)OR, N(R)C(O)R, N(R)C(S)R, N(R)C(O)N(R)₂, N(R)C(S)N(R)₂, N(COR)COR, N(OR)R, C(═NH)N(R)₂, C(O)N(OR)R, C(═NOR)R, and substituted or unsubstituted (C₁-C₁₀₀)hydrocarbyl, wherein R can be hydrogen (in examples that include other carbon atoms) or a carbon-based moiety, and wherein the carbon-based moiety can be substituted or unsubstituted.

The term “substituted” as used herein in conjunction with a molecule or an organic group as defined herein refers to the state in which one or more hydrogen atoms contained therein are replaced by one or more non-hydrogen atoms. The term “functional group” or “substituent” as used herein refers to a group that can be or is substituted onto a molecule or onto an organic group. Examples of substituents or functional groups include, but are not limited to, a halogen (e.g., F, Cl, Br, and I); an oxygen atom in groups such as hydroxy groups, alkoxy groups, aryloxy groups, aralkyloxy groups, oxo(carbonyl) groups, carboxyl groups including carboxylic acids, carboxylates, and carboxylate esters; a sulfur atom in groups such as thiol groups, alkyl and aryl sulfide groups, sulfoxide groups, sulfone groups, sulfonyl groups, and sulfonamide groups; a nitrogen atom in groups such as amines, hydroxyamines, nitriles, nitro groups, N-oxides, hydrazides, azides, and enamines; and other heteroatoms in various other groups. Non-limiting examples of substituents that can be bonded to a substituted carbon (or other) atom include F, Cl, Br, I, OR, OC(O)N(R)₂, CN, NO, NO₂, ONO₂, azido, CF₃, OCF₃, R, O (oxo), S (thiono), C(O), S(O), methylenedioxy, ethylenedioxy, N(R)₂, SR, SOR, SO₂R, SO₂N(R)₂, SO₃R, C(O)R, C(O)C(O)R, C(O)CH₂C(O)R, C(S)R, C(O)OR, OC(O)R, C(O)N(R)₂, OC(O)N(R)₂, C(S)N(R)₂, (CH₂)₀₋₂N(R)C(O)R, (CH₂)₀₋₂N(R)N(R)₂, N(R)N(R)C(O)R, N(R)N(R)C(O)OR, N(R)N(R)CON(R)₂, N(R)SO₂R, N(R)SO₂N(R)₂, N(R)C(O)OR, N(R)C(O)R, N(R)C(S)R, N(R)C(O)N(R)₂, N(R)C(S)N(R)₂, N(COR)COR, N(OR)R, C(═NH)N(R)₂, C(O)N(OR)R, and C(═NOR)R, wherein R can be hydrogen or a carbon-based moiety; for example, R can be hydrogen, (C₁-C₁₀₀)hydrocarbyl, alkyl, acyl, cycloalkyl, aryl, aralkyl, heterocyclyl, heteroaryl, or heteroarylalkyl; or wherein two R groups bonded to a nitrogen atom or to adjacent nitrogen atoms can together with the nitrogen atom or atoms form a heterocyclyl.

The term “alkyl” as used herein refers to straight chain and branched alkyl groups and cycloalkyl groups having from 1 to 40 carbon atoms, 1 to about 20 carbon atoms, 1 to 12 carbons or, in some embodiments, from 1 to 8 carbon atoms. Examples of straight chain alkyl groups include those with from 1 to 8 carbon atoms such as methyl, ethyl, n-propyl, n-butyl, n-pentyl, n-hexyl, n-heptyl, and n-octyl groups. Examples of branched alkyl groups include, but are not limited to, isopropyl, iso-butyl, sec-butyl, t-butyl, neopentyl, isopentyl, and 2,2-dimethylpropyl groups. As used herein, the term “alkyl” encompasses n-alkyl, isoalkyl, and anteisoalkyl groups as well as other branched chain forms of alkyl. Representative substituted alkyl groups can be substituted one or more times with any of the groups listed herein, for example, amino, hydroxy, cyano, carboxy, nitro, thio, alkoxy, and halogen groups.

The term “alkenyl” as used herein refers to straight and branched chain and cyclic alkyl groups as defined herein, except that at least one double bond exists between two carbon atoms. Thus, alkenyl groups have from 2 to 40 carbon atoms, or 2 to about 20 carbon atoms, or 2 to 12 carbon atoms or, in some embodiments, from 2 to 8 carbon atoms. Examples include, but are not limited to vinyl, —CH═C═CCH₂, —CH═CH(CH₃), —CH═C(CH₃)₂, —C(CH₃)═CH₂, —C(CH₃)═CH(CH₃), —C(CH₂CH₃)═CH₂, cyclohexenyl, cyclopentenyl, cyclohexadienyl, butadienyl, pentadienyl, and hexadienyl among others.

The term “alkynyl” as used herein refers to straight and branched chain alkyl groups, except that at least one triple bond exists between two carbon atoms. Thus, alkynyl groups have from 2 to 40 carbon atoms, 2 to about 20 carbon atoms, or from 2 to 12 carbons or, in some embodiments, from 2 to 8 carbon atoms. Examples include, but are not limited to —C≡CH, —C≡C(CH₃), —C≡C(CH₂CH₃), —CH₂C≡CH, —CH₂C≡C(CH₃), and —CH₂C≡C(CH₂CH₃) among others.

The term “acyl” as used herein refers to a group containing a carbonyl moiety wherein the group is bonded via the carbonyl carbon atom. The carbonyl carbon atom is bonded to a hydrogen forming a “formyl” group or is bonded to another carbon atom, which can be part of an alkyl, aryl, aralkyl cycloalkyl, cycloalkylalkyl, heterocyclyl, heterocyclylalkyl, heteroaryl, heteroarylalkyl group or the like. An acyl group can include 0 to about 12, 0 to about 20, or 0 to about 40 additional carbon atoms bonded to the carbonyl group. An acyl group can include double or triple bonds within the meaning herein. An acryloyl group is an example of an acyl group. An acyl group can also include heteroatoms within the meaning herein. A nicotinoyl group (pyridyl-3-carbonyl) is an example of an acyl group within the meaning herein. Other examples include acetyl, benzoyl, phenylacetyl, pyridylacetyl, cinnamoyl, and acryloyl groups and the like. When the group containing the carbon atom that is bonded to the carbonyl carbon atom contains a halogen, the group is termed a “haloacyl” group. An example is a trifluoroacetyl group.

The term “cycloalkyl” as used herein refers to cyclic alkyl groups such as, but not limited to, cyclopropyl, cyclobutyl, cyclopentyl, cyclohexyl, cycloheptyl, and cyclooctyl groups. In some embodiments, the cycloalkyl group can have 3 to about 8-12 ring members, whereas in other embodiments the number of ring carbon atoms range from 3 to 4, 5, 6, or 7. Cycloalkyl groups further include polycyclic cycloalkyl groups such as, but not limited to, norbornyl, adamantyl, bornyl, camphenyl, isocamphenyl, and carenyl groups, and fused rings such as, but not limited to, decalinyl, and the like. Cycloalkyl groups also include rings that are substituted with straight or branched chain alkyl groups as defined herein. Representative substituted cycloalkyl groups can be mono-substituted or substituted more than once, such as, but not limited to, 2,2-, 2,3-, 2,4-2,5- or 2,6-disubstituted cyclohexyl groups or mono-, di- or tri-substituted norbornyl or cycloheptyl groups, which can be substituted with, for example, amino, hydroxy, cyano, carboxy, nitro, thio, alkoxy, and halogen groups. The term “cycloalkenyl” alone or in combination denotes a cyclic alkenyl group.

The term “aryl” as used herein refers to cyclic aromatic hydrocarbon groups that do not contain heteroatoms in the ring. Thus aryl groups include, but are not limited to, phenyl, azulenyl, heptalenyl, biphenyl, indacenyl, fluorenyl, phenanthrenyl, triphenylenyl, pyrenyl, naphthacenyl, chrysenyl, biphenylenyl, anthracenyl, and naphthyl groups. In some embodiments, aryl groups contain about 6 to about 14 carbons in the ring portions of the groups. Aryl groups can be unsubstituted or substituted, as defined herein. Representative substituted aryl groups can be mono-substituted or substituted more than once, such as, but not limited to, a phenyl group substituted at any one or more of 2-, 3-, 4-, 5-, or 6-positions of the phenyl ring, or a naphthyl group substituted at any one or more of 2- to 8-positions thereof.

The term “aralkyl” as used herein refers to alkyl groups as defined herein in which a hydrogen or carbon bond of an alkyl group is replaced with a bond to an aryl group as defined herein. Representative aralkyl groups include benzyl and phenylethyl groups and fused (cycloalkylaryl)alkyl groups such as 4-ethyl-indanyl. Aralkenyl groups are alkenyl groups as defined herein in which a hydrogen or carbon bond of an alkyl group is replaced with a bond to an aryl group as defined herein.

The term “heterocyclyl” as used herein refers to aromatic and non-aromatic ring compounds containing three or more ring members, of which one or more is a heteroatom such as, but not limited to, N, O, and S. Thus, a heterocyclyl can be a cycloheteroalkyl, or a heteroaryl, or if polycyclic, any combination thereof. In some embodiments, heterocyclyl groups include 3 to about 20 ring members, whereas other such groups have 3 to about 15 ring members. A heterocyclyl group designated as a C₂-heterocyclyl can be a 5-ring with two carbon atoms and three heteroatoms, a 6-ring with two carbon atoms and four heteroatoms and so forth. Likewise a C₄-heterocyclyl can be a 5-ring with one heteroatom, a 6-ring with two heteroatoms, and so forth. The number of carbon atoms plus the number of heteroatoms equals the total number of ring atoms. A heterocyclyl ring can also include one or more double bonds. A heteroaryl ring is an embodiment of a heterocyclyl group. The phrase “heterocyclyl group” includes fused ring species including those that include fused aromatic and non-aromatic groups. For example, a dioxolanyl ring and a benzdioxolanyl ring system (methylenedioxyphenyl ring system) are both heterocyclyl groups within the meaning herein. The phrase also includes polycyclic ring systems containing a heteroatom such as, but not limited to, quinuclidyl. Heterocyclyl groups can be unsubstituted, or can be substituted as discussed herein. Heterocyclyl groups include, but are not limited to, pyrrolidinyl, piperidinyl, piperazinyl, morpholinyl, pyrrolyl, pyrazolyl, triazolyl, tetrazolyl, oxazolyl, isoxazolyl, thiazolyl, pyridinyl, thiophenyl, benzothiophenyl, benzofuranyl, dihydrobenzofuranyl, indolyl, dihydroindolyl, azaindolyl, indazolyl, benzimidazolyl, azabenzimidazolyl, benzoxazolyl, benzothiazolyl, benzothiadiazolyl, imidazopyridinyl, isoxazolopyridinyl, thianaphthalenyl, purinyl, xanthinyl, adeninyl, guaninyl, quinolinyl, isoquinolinyl, tetrahydroquinolinyl, quinoxalinyl, and quinazolinyl groups. Representative substituted heterocyclyl groups can be mono-substituted or substituted more than once, such as, but not limited to, piperidinyl or quinolinyl groups, which are 2-, 3-, 4-, 5-, or 6-substituted, or disubstituted with groups such as those listed herein.

The term “heteroaryl” as used herein refers to aromatic ring compounds containing 5 or more ring members, of which, one or more is a heteroatom such as, but not limited to, N, O, and S; for instance, heteroaryl rings can have 5 to about 8-12 ring members. A heteroaryl group is a variety of a heterocyclyl group that possesses an aromatic electronic structure. A heteroaryl group designated as a C₂-heteroaryl can be a 5-ring with two carbon atoms and three heteroatoms, a 6-ring with two carbon atoms and four heteroatoms and so forth. Likewise a C₄-heteroaryl can be a 5-ring with one heteroatom, a 6-ring with two heteroatoms, and so forth. The number of carbon atoms plus the number of heteroatoms sums up to equal the total number of ring atoms. Heteroaryl groups include, but are not limited to, groups such as pyrrolyl, pyrazolyl, triazolyl, tetrazolyl, oxazolyl, isoxazolyl, thiazolyl, pyridinyl, thiophenyl, benzothiophenyl, benzofuranyl, indolyl, azaindolyl, indazolyl, benzimidazolyl, azabenzimidazolyl, benzoxazolyl, benzothiazolyl, benzothiadiazolyl, imidazopyridinyl, isoxazolopyridinyl, thianaphthalenyl, purinyl, xanthinyl, adeninyl, guaninyl, quinolinyl, isoquinolinyl, tetrahydroquinolinyl, quinoxalinyl, and quinazolinyl groups. Heteroaryl groups can be unsubstituted, or can be substituted with groups as is discussed herein. Representative substituted heteroaryl groups can be substituted one or more times with groups such as those listed herein.

Additional examples of aryl and heteroaryl groups include but are not limited to phenyl, biphenyl, indenyl, naphthyl (1-naphthyl, 2-naphthyl), N-hydroxytetrazolyl, N-hydroxytriazolyl, N-hydroxyimidazolyl, anthracenyl (1-anthracenyl, 2-anthracenyl, 3-anthracenyl), thiophenyl (2-thienyl, 3-thienyl), furyl (2-furyl, 3-furyl), indolyl, oxadiazolyl, isoxazolyl, quinazolinyl, fluorenyl, xanthenyl, isoindanyl, benzhydryl, acridinyl, thiazolyl, pyrrolyl (2-pyrrolyl), pyrazolyl (3-pyrazolyl), imidazolyl (1-imidazolyl, 2-imidazolyl, 4-imidazolyl, 5-imidazolyl), triazolyl (1,2,3-triazol-1-yl, 1,2,3-triazol-2-yl 1,2,3-triazol-4-yl, 1,2,4-triazol-3-yl), oxazolyl (2-oxazolyl, 4-oxazolyl, 5-oxazolyl), thiazolyl (2-thiazolyl, 4-thiazolyl, 5-thiazolyl), pyridyl (2-pyridyl, 3-pyridyl, 4-pyridyl), pyrimidinyl (2-pyrimidinyl, 4-pyrimidinyl, 5-pyrimidinyl, 6-pyrimidinyl), pyrazinyl, pyridazinyl (3-pyridazinyl, 4-pyridazinyl, 5-pyridazinyl), quinolyl (2-quinolyl, 3-quinolyl, 4-quinolyl, 5-quinolyl, 6-quinolyl, 7-quinolyl, 8-quinolyl), isoquinolyl (1-isoquinolyl, 3-isoquinolyl, 4-isoquinolyl, 5-isoquinolyl, 6-isoquinolyl, 7-isoquinolyl, 8-isoquinolyl), benzo[b]furanyl (2-benzo[b]furanyl, 3-benzo[b]furanyl, 4-benzo[b]furanyl, 5-benzo[b]furanyl, 6-benzo[b]furanyl, 7-benzo[b]furanyl), 2,3-dihydro-benzo[b]furanyl (2-(2,3-dihydro-benzo[b]furanyl), 3-(2,3-dihydro-benzo[b]furanyl), 4-(2,3-dihydro-benzo[b]furanyl), 5-(2,3-dihydro-benzo[b]furanyl), 6-(2,3-dihydro-benzo[b]furanyl), 7-(2,3-dihydro-benzo[b]furanyl), benzo[b]thiophenyl (2-benzo[b]thiophenyl, 3-benzo[b]thiophenyl, 4-benzo[b]thiophenyl, 5-benzo[b]thiophenyl, 6-benzo[b]thiophenyl, 7-benzo[b]thiophenyl), 2,3-dihydro-benzo[b]thiophenyl, (2-(2,3-dihydro-benzo[b]thiophenyl), 3-(2,3-dihydro-benzo[b]thiophenyl), 4-(2,3-dihydro-benzo[b]thiophenyl), 5-(2,3-dihydro-benzo[b]thiophenyl), 6-(2,3-dihydro-benzo[b]thiophenyl), 7-(2,3-dihydro-benzo[b]thiophenyl), indolyl (1-indolyl, 2-indolyl, 3-indolyl, 4-indolyl, 5-indolyl, 6-indolyl, 7-indolyl), indazole (1-indazolyl, 3-indazolyl, 4-indazolyl, 5-indazolyl, 6-indazolyl, 7-indazolyl), benzimidazolyl (1-benzimidazolyl, 2-benzimidazolyl, 4-benzimidazolyl, 5-benzimidazolyl, 6-benzimidazolyl, 7-benzimidazolyl, 8-benzimidazolyl), benzoxazolyl (1-benzoxazolyl, 2-benzoxazolyl), benzothiazolyl (1-benzothiazolyl, 2-benzothiazolyl, 4-benzothiazolyl, 5-benzothiazolyl, 6-benzothiazolyl, 7-benzothiazolyl), carbazolyl (1-carbazolyl, 2-carbazolyl, 3-carbazolyl, 4-carbazolyl), 5H-dibenz[b,f]azepine (5H-dibenz[b,f]azepin-1-yl, 5H-dibenz[b,f]azepine-2-yl, 5H-dibenz[b,f]azepine-3-yl, 5H-dibenz[b,f]azepine-4-yl, 5H-dibenz[b,f]azepine-5-yl), 10,11-dihydro-5H-dibenz[b,f]azepine (10,11-dihydro-5H-dibenz[b,f]azepine-1-yl, 10,11-dihydro-5H-dibenz[b,f]azepine-2-yl, 10,11-dihydro-5H-dibenz[b,f]azepine-3-yl, 10,11-dihydro-5H-dibenz[b,f]azepine-4-yl, 10,11-dihydro-5H-dibenz[b,f]azepine-5-yl), and the like.

The term “heterocyclylalkyl” as used herein refers to alkyl groups as defined herein in which a hydrogen or carbon bond of an alkyl group as defined herein is replaced with a bond to a heterocyclyl group as defined herein. Representative heterocyclyl alkyl groups include, but are not limited to, furan-2-yl methyl, furan-3-yl methyl, pyridine-3-yl methyl, tetrahydrofuran-2-yl ethyl, and indol-2-yl propyl.

The term “heteroarylalkyl” as used herein refers to alkyl groups as defined herein in which a hydrogen or carbon bond of an alkyl group is replaced with a bond to a heteroaryl group as defined herein.

The term “alkoxy” as used herein refers to an oxygen atom connected to an alkyl group, including a cycloalkyl group, as are defined herein. Examples of linear alkoxy groups include but are not limited to methoxy, ethoxy, propoxy, butoxy, pentyloxy, hexyloxy, and the like. Examples of branched alkoxy include but are not limited to isopropoxy, sec-butoxy, tert-butoxy, isopentyloxy, isohexyloxy, and the like. Examples of cyclic alkoxy include but are not limited to cyclopropyloxy, cyclobutyloxy, cyclopentyloxy, cyclohexyloxy, and the like. An alkoxy group can include about 1 to about 12, about 1 to about 20, or about 1 to about 40 carbon atoms bonded to the oxygen atom, and can further include double or triple bonds, and can also include heteroatoms. For example, an allyloxy group or a methoxyethoxy group is also an alkoxy group within the meaning herein, as is a methylenedioxy group in a context where two adjacent atoms of a structure are substituted therewith.

The term “amine” as used herein refers to primary, secondary, and tertiary amines having, e.g., the formula N(group)₃ wherein each group can independently be H or non-H, such as alkyl, aryl, and the like. Amines include but are not limited to R—NH₂, for example, alkylamines, arylamines, alkylarylamines; R₂NH wherein each R is independently selected, such as dialkylamines, diarylamines, aralkylamines, heterocyclylamines and the like; and R₃N wherein each R is independently selected, such as trialkylamines, dialkylarylamines, alkyldiarylamines, triarylamines, and the like. The term “amine” also includes ammonium ions as used herein.

The term “amino group” as used herein refers to a substituent of the form —NH₂, —NHR, —NR₂, —NR₃⁺, wherein each R is independently selected, and protonated forms of each, except for —NR₃⁺, which cannot be protonated. Accordingly, any compound substituted with an amino group can be viewed as an amine. An “amino group” within the meaning herein can be a primary, secondary, tertiary, or quaternary amino group. An “alkylamino” group includes a monoalkylamino, dialkylamino, and trialkylamino group.

The terms “halo,” “halogen,” or “halide” group, as used herein, by themselves or as part of another substituent, mean, unless otherwise stated, a fluorine, chlorine, bromine, or iodine atom.

The term “haloalkyl” group, as used herein, includes mono-halo alkyl groups, poly-halo alkyl groups wherein all halo atoms can be the same or different, and per-halo alkyl groups, wherein all hydrogen atoms are replaced by halogen atoms, such as fluoro. Examples of haloalkyl include trifluoromethyl, 1,1-dichloroethyl, 1,2-dichloroethyl, 1,3-dibromo-3,3-difluoropropyl, perfluorobutyl, and the like.

The term “monovalent” as used herein refers to a substituent connecting via a single bond to a substituted molecule. When a substituent is monovalent, such as, for example, F or Cl, it is bonded to the atom it is substituting by a single bond.

The term “hydrocarbon” or “hydrocarbyl” as used herein refers to a molecule or functional group that includes carbon and hydrogen atoms. The term can also refer to a molecule or functional group that normally includes both carbon and hydrogen atoms but wherein all the hydrogen atoms are substituted with other functional groups.

As used herein, the term “hydrocarbyl” refers to a functional group derived from a straight chain, branched, or cyclic hydrocarbon, and can be alkyl, alkenyl, alkynyl, aryl, cycloalkyl, acyl, or any combination thereof. Hydrocarbyl groups can be shown as (Cₐ-C_{b})hydrocarbyl, wherein a and b are integers and mean having any of a to b number of carbon atoms. For example, (C₁-C₄)hydrocarbyl means the hydrocarbyl group can be methyl (C₁), ethyl (C₂), propyl (C₃), or butyl (C₄), and (C₀-C_{b})hydrocarbyl means in certain embodiments there is no hydrocarbyl group. In certain embodiments, the hydrocarbyl is optionally substituted C₁₋₁₂ alkyl. In certain embodiments, the hydrocarbyl is optionally substituted C₂₋₁₂ alkenyl. In certain embodiments, the hydrocarbyl is optionally substituted C₂₋₁₂ alkynyl. In certain embodiments, the hydrocarbyl is optionally substituted C₃₋₁₂ cycloalkyl. In certain embodiments, the hydrocarbyl is optionally substituted C₁₋₁₂ heteroalkyl. In certain embodiments, the hydrocarbyl is optionally substituted C₁₋₁₂ alkoxy. In certain embodiments, the hydrocarbyl is optionally substituted C₆₋₁₄ aryl, and/or optionally substituted C₆₋₁₂ aryl, and/or optionally substituted C₆₋₁₀ aryl. In certain embodiments, the hydrocarbyl is optionally substituted C₂-C₁₂ heterocyclyl. In certain embodiments, the hydrocarbyl is optionally substituted C₄-C₁₂ heteroaryl. In certain embodiments, the hydrocarbyl is optionally substituted C₁₋₁₂ acyl.

The term “solvent” as used herein refers to a liquid that can dissolve a solid, liquid, or gas. Non-limiting examples of solvents are silicones, organic compounds, water, alcohols, ionic liquids, and supercritical fluids.

The term “independently selected from” as used herein refers to referenced groups being the same, different, or a mixture thereof, unless the context clearly indicates otherwise. Thus, under this definition, the phrase “X¹, X², and X³ are independently selected from noble gases” would include the scenario where, for example, X¹, X², and X³ are all the same, where X¹, X², and X³ are all different, where X¹ and X² are the same but X³ is different, and other analogous permutations.

The term “room temperature” as used herein refers to a temperature of about 15° C. to 28° C.

The term “standard temperature and pressure” as used herein refers to 20° C. and 101 kPa.

As used herein, the term “composition” or “pharmaceutical composition” refers to a mixture of at least one compound described herein with a pharmaceutically acceptable carrier. The pharmaceutical composition facilitates administration of the compound to a patient or subject. Multiple techniques of administering a compound exist in the art including, but not limited to, intravenous, oral, aerosol, parenteral, ophthalmic, pulmonary and topical administration.

The abbreviation “Np” as used herein means naphthyl. Thus 1-Np is 1-naphthyl, and 2-Np is 2-naphthyl.

### Preparation of Compounds

Compounds of Formula I or otherwise described herein can be prepared by the general schemes described herein, using the synthetic method known by those skilled in the art. The following examples illustrate non-limiting embodiments of the compound(s) described herein and their preparation.

In various embodiments, the disclosure provides a compound of Formula I, or a salt, solvate, geometric isomer, or stereoisomer thereof:

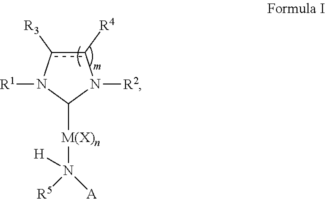

wherein:

[symbol] is a single or double bond;

R¹ and R² are each independently C₃₋₁₀ cycloalkyl, aryl, or heteroaryl, each of which is optionally substituted by at least one group selected from the group consisting of halogen, OR, SiR₃, OSiR₃, OSiR₃, OSi(OR)₃, BR₃, BR₂, B(OR)₃, B(OR)₂, CN, CF₃, OCF₃, SO₂R, SO₂N(R)₂, SO₃R, C(O)R, NR₂, N(R)SO₂R, N(R)SO₂N(R)₂, (CH₂)₀₋₂N(R)C(O)R, (CH₂)₀₋₂N(R)N(R)₂, N(R)C(O)OR, C₁₋₁₂ alkyl, C₁₋₁₂ heteroalkyl, OC₁₋₁₂ alkyl, C₃₋₁₂ cycloalkyl, C₆₋₁₀ aryl, and C₆₋₁₀ heteroaryl;

R³ and R⁴ are each independently hydrogen, optionally substituted C₃₋₁₀ cycloalkyl, optionally substituted aryl, and optionally substituted heteroaryl, C₁₋₁₂ alkyl, or OC₁₋₁₂ alkyl, wherein the optional substitution comprises at least one group selected from the group consisting of halogen, OR, SiR₃, OSiR₃, OSiR₃, OSi(OR)₃, BR₃, BR₂, B(OR)₃, B(OR)₂, CN, CF₃, OCF₃, SO₂R, SO₂N(R)₂, SO₃R, C(O)R, NR₂, N(R)SO₂R, N(R)SO₂N(R)₂, (CH₂)₀₋₂N(R)C(O)R, (CH₂)₀₋₂N(R)N(R)₂, N(R)C(O)OR, C₁₋₁₂ alkyl, C₁₋₁₂ heteroalkyl, OC₁₋₁₂ alkyl, C₃₋₁₂ cycloalkyl, C₆₋₁₀ aryl, and C₆₋₁₀ heteroaryl; or

R³ and R⁴ taken together with the ring to which they are attached are used to form a C₄₋₂₀ cycloalkyl, C₆₋₂₀ aryl, or C₆₋₂₀ heteroaryl, each of which is optionally substituted by at least one group selected from the group consisting of halogen, OR, SiR₃, OSiR₃, OSiR₃, OSi(OR)₃, BR₃, BR₂, B(OR)₃, B(OR)₂, CN, CF₃, OCF₃, SO₂R, SO₂N(R)₂, SO₃R, C(O)R, NR₂, N(R)SO₂R, N(R)SO₂N(R)₂, (CH₂)₀₋₂N(R)C(O)R, (CH₂)₀₋₂N(R)N(R)₂, N(R)C(O)OR, C₁₋₁₂ alkyl, C₁₋₁₂ heteroalkyl, OC₁₋₁₂ alkyl, C₃₋₁₂ cycloalkyl, C₆₋₁₀ aryl, and C₆₋₁₀ heteroaryl;

R⁵ is H or optionally substituted C₁₋₃ alkyl;

M is a transition metal;

X is a counter anion;

A is an aryl or heteroaryl optionally substituted by at least one group selected from the group consisting of halogen, OR, SiR₃, OSiR₃, OSiR₃, OSi(OR)₃, BR₃, BR₂, B(OR)₃, B(OR)₂, CN, CF₃, OCF₃, SO₂R, SO₂N(R)₂, SO₃R, C(O)R, NR₂, N(R)SO₂R, N(R)SO₂N(R)₂, (CH₂)₀₋₂N(R)C(O)R, (CH₂)₀₋₂N(R)N(R)₂, N(R)C(O)OR, C₁₋₁₂ alkyl, C₁₋₁₂ heteroalkyl, OC₁₋₁₂ alkyl, C₃₋₁₂ cycloalkyl, C₆₋₁₀ aryl, and C₆₋₁₀ heteroaryl;

R is independently at each occurrence hydrogen or optionally substituted C₁-10 alkyl;

m is 1, 2, or 3; and

n is 1, 2, 3, or 4.

The nature of variable A in the compound of Formula I is not particularly limited, provided that stable complexes with transition metals can be formed with the ligands described herein and the resulting transition metal complexes possess catalytic activity. Other suitable A moieties include anthracenes (e.g. 1-aminoanthracene, 2-aminoanthracene, 9-aminoanthracene); aminobiphenyls (e.g. 4-aminobiphenyl); aminophenanthrenes (e.g. 1-aminophenanthrene, 2-aminophenanthrene, 9-aminophenanthrene); aminopyrenes (e.g. 1-aminopyrene, 2-aminopyrene); aminochrysenes (e.g. 1-aminochrysene, 2-aminochrysene, 6-aminochrysene); aminofluorenes (e.g. 1-aminofluorene, 2-aminofluorene); naphthalenes (e.g. 1-aminonaphthalene, 2-aminonaphthalene); acridines (e.g. 9-aminoacridine, 2-aminoacridine); quinolines (e.g. 8-aminoquinoline, 2-aminoquinoline, 5-aminoquinoline); and the like. Any of the aryl or heteroaryl amines described herein can be primary or secondary amines.

In some embodiments, the compound has the structure of Formula Ia, or a salt, solvate, geometric isomer, or stereoisomer thereof:

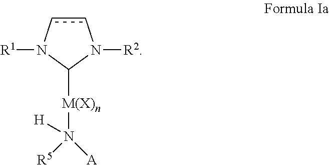

In some embodiments, the compound has the structure of Formula Ib, Formula Ic, Formula Id, Formula Ie, or Formula If, or a salt, solvate, geometric isomer, or stereoisomer thereof:

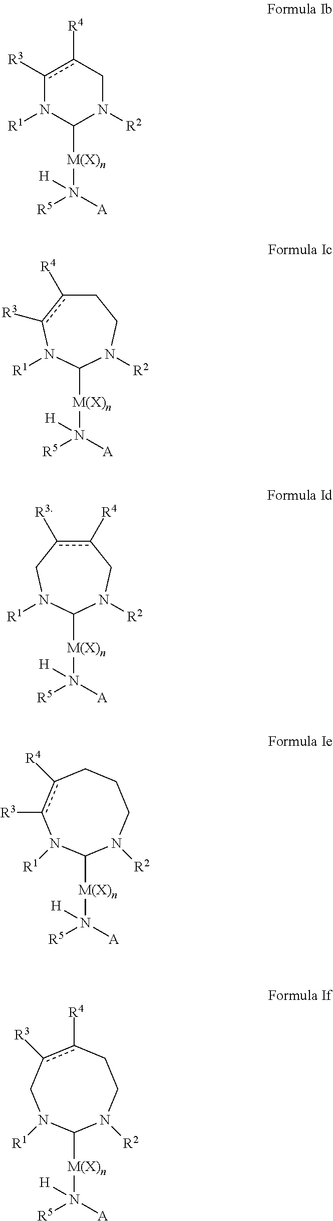

In some embodiments, R¹ and R² are both aryl. In various embodiments, the aryl group has the structure:

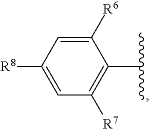

or a salt, solvate, geometric isomer, or stereoisomer thereof, wherein:
R⁶ and R⁷ are each independently C₁₋₁₂ alkyl or C₁₋₁₂ alkyl substituted by at least one aryl; and
R⁸ is hydrogen or C₁₋₁₂ alkyl or C₁₋₁₂ alkyl substituted by at least one aryl.

In some embodiments, R⁸ is hydrogen. In various embodiments, R⁶ and R⁷ are each C₁₋₆ alkyl. In some embodiments, R⁶ and R⁷ are each C(H)(CH₃)₂. In various embodiments, M is selected from the group consisting of Fe, Co, Ni, Cu, Ru, Rh, Pd, Ag, Re, Os, Ir, Pt, and Au. In some embodiments, M is Pd. In various embodiments, X is selected from the group consisting of F, Cl, Br, I, OSO₂R, OSO₃R, and OC(═O)R. In some embodiments, X is Cl. In various embodiments, m is 1. In various embodiments, n is 2.

In some embodiments, A is

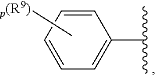

and
each occurrence of R⁹ is independently selected from the group consisting of OCH₃, CF₃, 2,6-dimethyl, 2,6-di-isopropyl, and hydrogen, and p is 0, 1, 2, 3, 4, or 5. In some embodiments, R⁵ is hydrogen or methyl.

The compound of Formula I has three moieties, as show below:

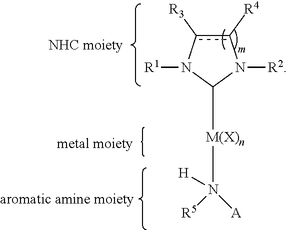

In various embodiments, the NHC moiety in the compound of Formula I is selected from the group consisting of:

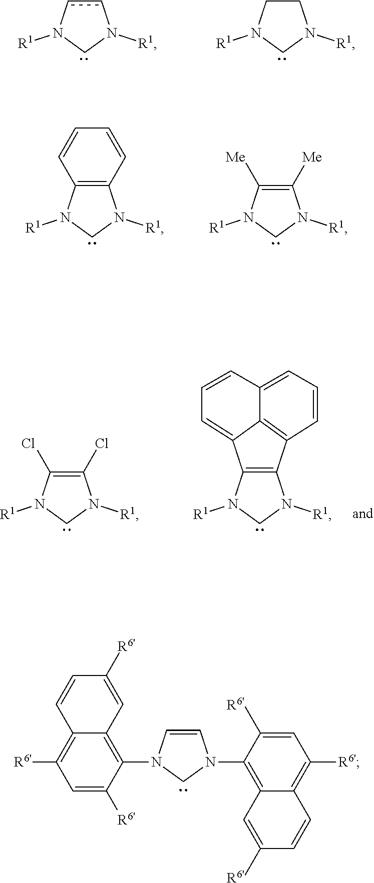

wherein
R¹ is selected from the group consisting of t-Bu, 1-adamantyl, cyclohexyl, i-Pr, methyl, ethyl, n-propyl, butyl, pentyl, and

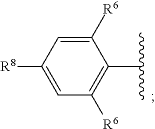

R⁶ is CH(phenyl)₂, CH(Me)₂, CH(2-Np)₂, or CH(Et)₂;
R⁶ is CH(phenyl)₂, CH(Me)₂, or CH(Et); and
R⁸ is CH(phenyl)₂, Me, OMe, or H.

In various embodiments, the NHC moiety in the compound of Formula I is selected from the group consisting of:

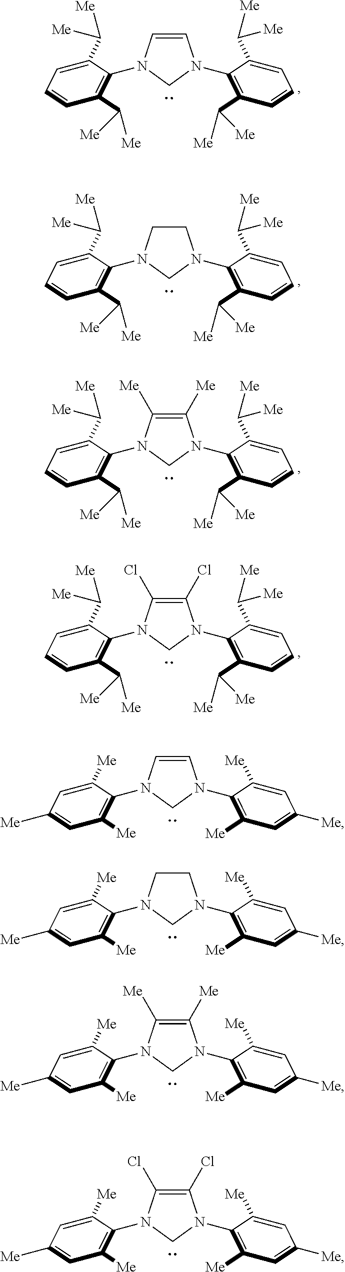

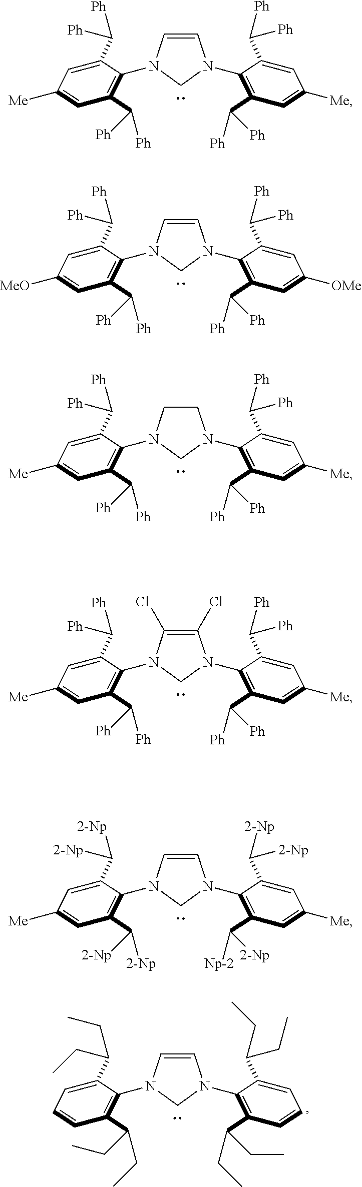

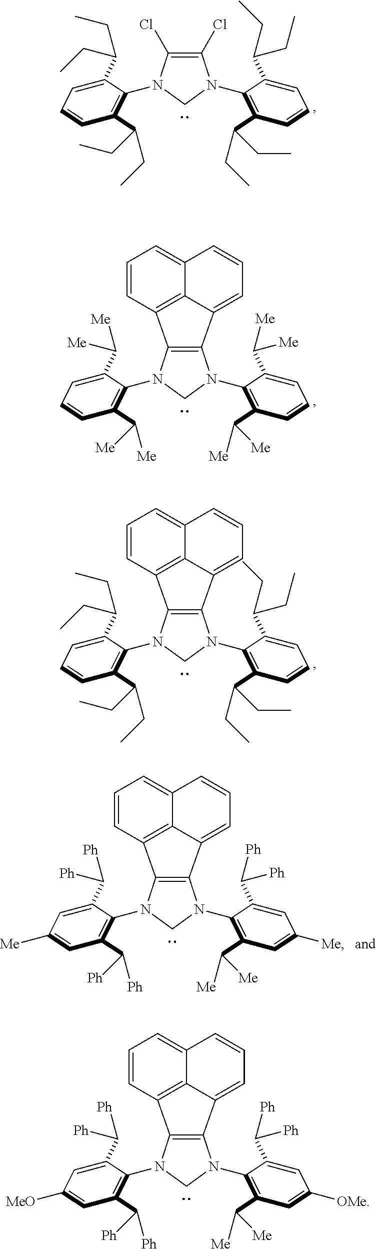

In various embodiments, a method of making the compound of Formula I, or a salt, solvate, geometric isomer, or stereoisomer thereof is provided. The method includes contacting a compound with the structure

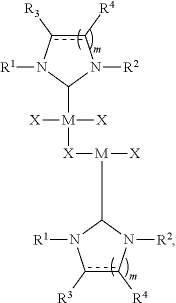

or a salt, solvate, geometric isomer, or stereoisomer thereof, with a compound with the structure of

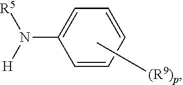

or a salt, solvate, geometric isomer, or stereoisomer thereof, in a solvent to form a compound of Formula I,

wherein each R⁹ is independently selected from the group consisting of hydrogen halogen, OR, SiR₃, OSiR₃, OSiR₃, OSi(OR)₃, BR₃, BR₂, B(OR)₃, B(OR)₂, CN, CF₃, OCF₃, SO₂R, SO₂N(R)₂, SO₃R, C(O)R, NR₂, N(R)SO₂R, N(R)SO₂N(R)₂, (CH₂)₀₋₂N(R)C(O)R, (CH₂)₀₋₂N(R)N(R)₂, N(R)C(O)OR, C₁₋₁₂ alkyl, C₁₋₁₂ heteroalkyl, OC₁₋₁₂ alkyl, C₃₋₁₂ cycloalkyl, C₆₋₁₀ aryl, and C₆₋₁₀ heteroaryl, and wherein p is 0, 1, 2, 3, 4, or 5.

In various embodiments, the solvent is a non-polar aprotic solvent. Suitable non-polar aprotic solvents include, without limitation, chloroform, diethyl ether, deuterated chloroform, pentane, hexanes, benzene, toluene, dichloromethane, or mixtures thereof. The contacting is performed at room temperature, in some embodiments.

Another method of making the compound of Formula I, or a salt, solvate, geometric isomer, or stereoisomer thereof, includes in some embodiments contacting a compound of Formula I-SM, or a salt, solvate, geometric isomer, or stereoisomer thereof,

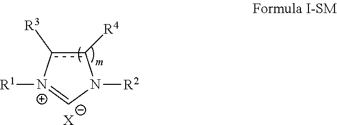

with a compound of formula MX₂(A-N(H)(R⁵))₂, or a salt, solvate, geometric isomer, or stereoisomer thereof, in a solvent to form the compound of Formula I, or a salt, solvate, geometric isomer, or stereoisomer thereof. This reaction is, in some embodiments, performed in the presence of a base. The compound of Formula I-SM can be a stable salt of any of the NHC moieties described herein.

Suitable bases include, without limitation, NaOC₁₋₄ alkyl, KOC₁₋₄ alkyl, lithium diisopropylamide, sodium hexamethyldisilazide, LiC₁₋₄ alkyl, or combinations thereof, and the like. In some embodiments, the reaction with base takes place in a polar aprotic solvent. Suitable polar aprotic solvents include, without limitation, tetrahydrofuran, 2-N-methylpyrrolidone, dimethyl formamide, acetonitrile, or mixtures thereof, and the like.

In various embodiments, the compound is a compound of Formula II, or a salt, solvate, geometric isomer, or stereoisomer thereof:

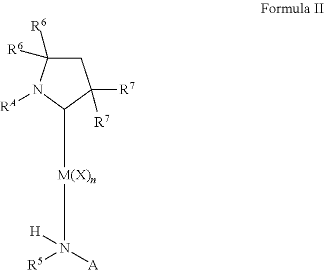

In the compound of Formula II, X and ‘n’ are as defined herein.

Each occurrence of R^{A}, R⁶ and R⁷ is independently chosen from optionally substituted C₁₋₁₂ alkyl, optionally substituted C₁₋₁₂ heteroalkyl, optionally substituted OC₁₋₁₂ alkyl, optionally substituted C₃₋₁₂ cycloalkyl, optionally substituted C₆₋₁₀ aryl, optionally substituted C₆₋₁₀ heteroaryl, A, R¹, or R². The optional substitution in R⁶ and R⁷ is at least one group selected from the group consisting of halogen, OR, SiR₃, OSiR₃, OSiR₃, OSi(OR)₃, BR₃, BR₂, B(OR)₃, B(OR)₂, CN, CF₃, OCF₃, SO₂R, SO₂N(R)₂, SO₃R, C(O)R, NR₂, N(R)SO₂R, N(R)SO₂N(R)₂, (CH₂)₀₋₂N(R)C(O)R, (CH₂)₀₋₂N(R)N(R)₂, N(R)C(O)OR, C₁₋₁₂ alkyl, C₁₋₁₂ heteroalkyl, OC₁₋₁₂ alkyl, C₃₋₁₂ cycloalkyl, C₆₋₁₀ aryl, and C₆₋₁₀ heteroaryl.

In various embodiments, the compound is a compound of Formula III, or a salt, solvate, geometric isomer, or stereoisomer thereof:

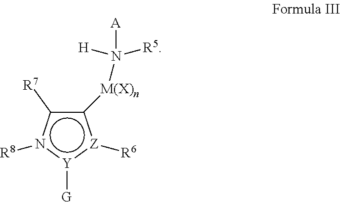

In the compound of Formula III, X, n, R⁶ and R⁷ are as defined herein. Variable R⁸ is defined the same as R⁶. Variable Y is N or C, Z is N or C, provided that both Y and Z cannot both be C. G is absent or defined the same as R⁶. Compounds of Formula III are mesoionic carbene complexes.

A compound of Formula III can be formed, for example, by the following reactions:

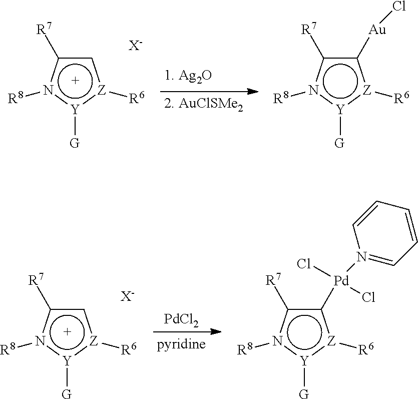

In various embodiments, the compound is a mesoionic carbene complex selected from the group consisting of:

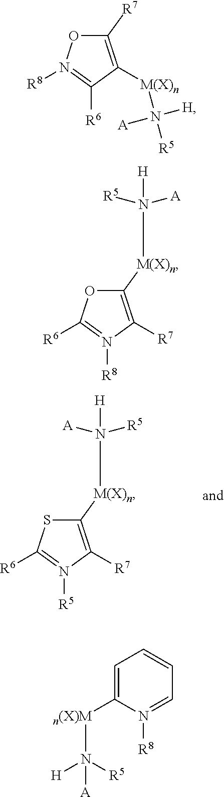

The compounds described herein can possess one or more stereocenters, and each stereocenter can exist independently in either the (R) or (S) configuration. In certain embodiments, compounds described herein are present in optically active or racemic forms. It is to be understood that the compounds described herein encompass racemic, optically-active, regioisomeric and stereoisomeric forms, or combinations thereof that possess the therapeutically useful properties described herein. Preparation of optically active forms is achieved in any suitable manner, including by way of non-limiting example, by resolution of the racemic form with recrystallization techniques, synthesis from optically-active starting materials, chiral synthesis, or chromatographic separation using a chiral stationary phase. In certain embodiments, a mixture of one or more isomer is utilized as the therapeutic compound described herein. In other embodiments, compounds described herein contain one or more chiral centers. These compounds are prepared by any means, including stereoselective synthesis, enantioselective synthesis and/or separation of a mixture of enantiomers and/or diastereomers. Resolution of compounds and isomers thereof is achieved by any means including, by way of non-limiting example, chemical processes, enzymatic processes, fractional crystallization, distillation, and chromatography.

The methods and formulations described herein include the use of N-oxides (if appropriate), crystalline forms (also known as polymorphs), solvates, amorphous phases, and/or pharmaceutically acceptable salts of compounds having the structure of any compound(s) described herein, as well as metabolites and active metabolites of these compounds having the same type of activity. Solvates include water, ether (e.g., tetrahydrofuran, methyl tert-butyl ether) or alcohol (e.g., ethanol) solvates, acetates and the like. In certain embodiments, the compounds described herein exist in solvated forms with pharmaceutically acceptable solvents such as water, and ethanol. In other embodiments, the compounds described herein exist in unsolvated form.

In certain embodiments, the compound(s) described herein can exist as tautomers. All tautomers are included within the scope of the compounds presented herein.

In certain embodiments, compounds described herein are prepared as prodrugs. A “prodrug” refers to an agent that is converted into the parent drug in vivo. In certain embodiments, upon in vivo administration, a prodrug is chemically converted to the biologically, pharmaceutically or therapeutically active form of the compound. In other embodiments, a prodrug is enzymatically metabolized by one or more steps or processes to the biologically, pharmaceutically or therapeutically active form of the compound.

In certain embodiments, sites on, for example, the aromatic ring portion of compound(s) described herein are susceptible to various metabolic reactions. Incorporation of appropriate substituents on the aromatic ring structures may reduce, minimize or eliminate this metabolic pathway. In certain embodiments, the appropriate substituent to decrease or eliminate the susceptibility of the aromatic ring to metabolic reactions is, by way of example only, a deuterium, a halogen, or an alkyl group.

Compounds described herein also include isotopically-labeled compounds wherein one or more atoms is replaced by an atom having the same atomic number, but an atomic mass or mass number different from the atomic mass or mass number usually found in nature. Examples of isotopes suitable for inclusion in the compounds described herein include and are not limited to ²H, ³H, ¹¹C, ¹³C, ¹⁴C, ³⁶Cl, ¹⁸F, ¹²³I, ¹²⁵I, ¹³N, ¹⁵N, ¹⁵O, ¹⁷O, ¹⁸O, ³²P, and ³⁵S. In certain embodiments, isotopically-labeled compounds are useful in drug and/or substrate tissue distribution studies. In other embodiments, substitution with heavier isotopes such as deuterium affords greater metabolic stability (for example, increased in vivo half-life or reduced dosage requirements). In yet other embodiments, substitution with positron emitting isotopes, such as ¹¹C, ¹⁸F, ¹⁵O and ¹³N, is useful in Positron Emission Topography (PET) studies for examining substrate receptor occupancy. Isotopically-labeled compounds are prepared by any suitable method or by processes using an appropriate isotopically-labeled reagent in place of the non-labeled reagent otherwise employed.

In certain embodiments, the compounds described herein are labeled by other means, including, but not limited to, the use of chromophores or fluorescent moieties, bioluminescent labels, or chemiluminescent labels.

The compounds described herein, and other related compounds having different substituents are synthesized using techniques and materials described herein and as described, for example, in Fieser & Fieser's Reagents for Organic Synthesis, Volumes 1-17 (John Wiley and Sons, 1991); Rodd's Chemistry of Carbon Compounds, Volumes 1-5 and Supplementals (Elsevier Science Publishers, 1989); Organic Reactions, Volumes 1-40 (John Wiley and Sons, 1991), Larock's Comprehensive Organic Transformations (VCH Publishers Inc., 1989), March, Advanced Organic Chemistry 4^{th} Ed., (Wiley 1992); Carey & Sundberg, Advanced Organic Chemistry 4th Ed., Vols. A and B (Plenum 2000,2001), and Green & Wuts, Protective Groups in Organic Synthesis 3rd Ed., (Wiley 1999) (all of which are incorporated by reference for such disclosure). General methods for the preparation of compound as described herein are modified by the use of appropriate reagents and conditions, for the introduction of the various moieties found in the formula as provided herein.

Compounds described herein are synthesized using any suitable procedures starting from compounds that are available from commercial sources, or are prepared using procedures described herein.

In certain embodiments, reactive functional groups, such as hydroxyl, amino, imino, thio or carboxy groups, are protected in order to avoid their unwanted participation in reactions. Protecting groups are used to block some or all of the reactive moieties and prevent such groups from participating in chemical reactions until the protective group is removed. In other embodiments, each protective group is removable by a different means. Protective groups that are cleaved under totally disparate reaction conditions fulfill the requirement of differential removal.

In certain embodiments, protective groups are removed by acid, base, reducing conditions (such as, for example, hydrogenolysis), and/or oxidative conditions. Groups such as trityl, dimethoxytrityl, acetal and t-butyldimethylsilyl are acid labile and are used to protect carboxy and hydroxy reactive moieties in the presence of amino groups protected with Cbz groups, which are removable by hydrogenolysis, and Fmoc groups, which are base labile. Carboxylic acid and hydroxy reactive moieties are blocked with base labile groups such as, but not limited to, methyl, ethyl, and acetyl, in the presence of amines that are blocked with acid labile groups, such as t-butyl carbamate, or with carbamates that are both acid and base stable but hydrolytically removable.

In certain embodiments, carboxylic acid and hydroxy reactive moieties are blocked with hydrolytically removable protective groups such as the benzyl group, while amine groups capable of hydrogen bonding with acids are blocked with base labile groups such as Fmoc. Carboxylic acid reactive moieties are protected by conversion to simple ester compounds as exemplified herein, which include conversion to alkyl esters, or are blocked with oxidatively-removable protective groups such as 2,4-dimethoxybenzyl, while co-existing amino groups are blocked with fluoride labile silyl carbamates.

Allyl blocking groups are useful in the presence of acid- and base-protecting groups since the former are stable and are subsequently removed by metal or pi-acid catalysts. For example, an allyl-blocked carboxylic acid is deprotected with a palladium-catalyzed reaction in the presence of acid labile t-butyl carbamate or base-labile acetate amine protecting groups. Yet another form of protecting group is a resin to which a compound or intermediate is attached. As long as the residue is attached to the resin, that functional group is blocked and does not react. Once released from the resin, the functional group is available to react.

Typically blocking/protecting groups may be selected from:

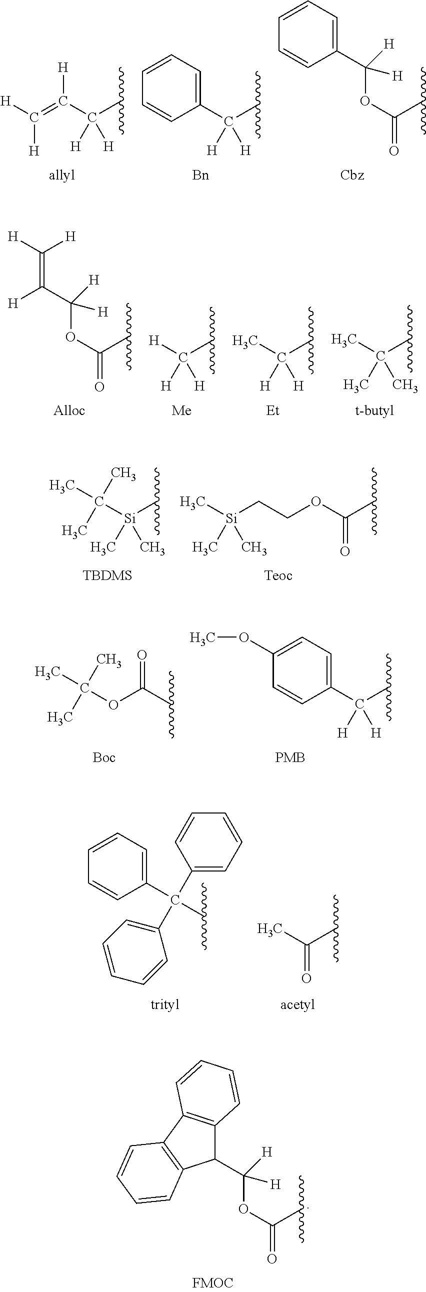

Other protecting groups, plus a detailed description of techniques applicable to the creation of protecting groups and their removal are described in Greene & Wuts, Protective Groups in Organic Synthesis, 3rd Ed., John Wiley & Sons, New York, N.Y., 1999, and Kocienski, Protective Groups, Thieme Verlag, New York, N.Y., 1994, which are incorporated herein by reference for such disclosure.

### Examples

Various embodiments of the present application can be better understood by reference to the following Examples which are offered by way of illustration. The scope of the present application is not limited to the Examples given herein.

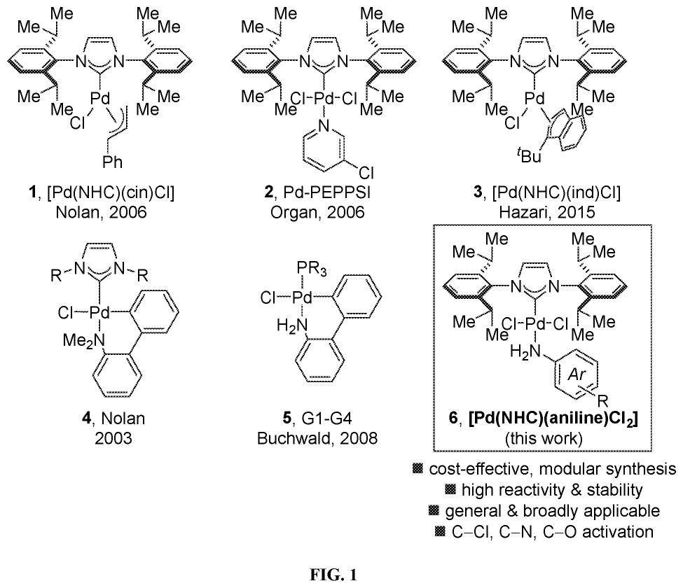

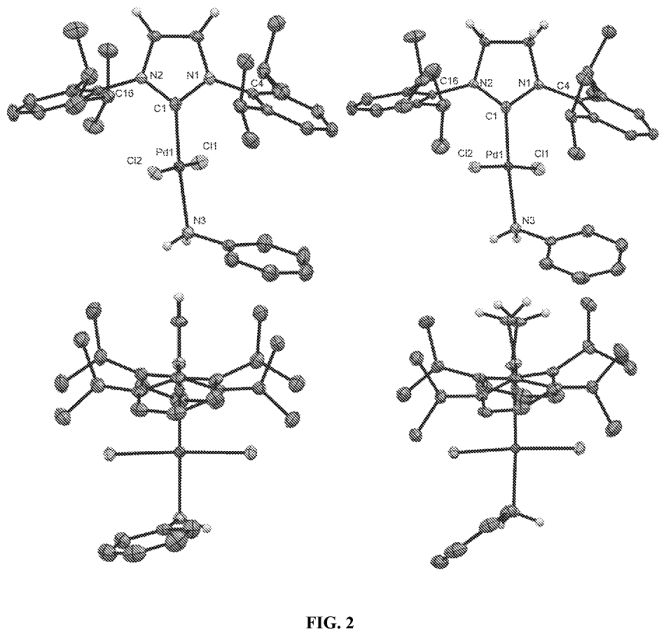

A number of well-define stable precatalysts have been emerged in recent years (FIG. 1, 1-5). Stabilization of palladium by the amine-type nitrogen is a key feature of Nolan's and Buchwald's palladacycles (FIG. 1, 4-5). The synthesis of compounds of Formula I, such as[(NHC)PdCl₂(aniline)] complexes is illustrated in Scheme 1. IPr was selected as a model NHC ancillary ligand because it is the privileged motif in Pd—NHC catalysis (6). In addition, a representative imidazolinylidene complex, Pd—SIPr, was synthesized (7). The synthesis of [(NHC)PdCl₂(aniline)] complexes was readily achieved by reacting anilines with [{Pd(NHC)(Cl)(ρ-Cl)}₂] dimers in CH₂Cl₂ at room temperature in excellent yields. [(NHC)PdCl₂(aniline)] complexes were isolated after trituration with cold pentanes. All complexes were found to be stable to air and moisture. Note that, if required, [(NHC)PdCl₂(aniline)] complexes are also amenable to chromatographic purification, which should facilitate their use. Complexes 6a and 7a were fully characterized by X-ray crystallography (FIG. 2, vide infra). In consideration of the utility of PdCl₂(aniline)₂ precursors for rapid screening of various NHCs, a direct synthesis [(IPr)PdCl₂(AN)] (AN=aniline) (Scheme 2) was developed. In some embodiments, IPrHCl (1.5 equiv) is reacted with Pd(PhNH₂)₂Cl₂ (1.0 equiv) and KOt-Bu (1.5 equiv) in THE at 80° C. to afford the well-defined [(IPr)PdCl₂(AN)] complex in 70% yield.

As shown in FIGS. 2A-2B, the complexes 6a and 7a adopt a slightly distorted square planar geometry (6a: C—Pd—N, 175.50; 7a: C—Pd—N, 175.3°). The C—Pd and Pd—N bond lengths are 1.970 Å and 2.109 Å in 6a and 1.967 Å and 2.116 Å in 7a, respectively. The Cl₁—Pd and Cl₂—Pd bond lengths are 2.2997 Å and 2.2.990 Å in 6a (Cl₁—Pd—Cl₂, 175.8°) and 2.299 Å and 2.285 Å (Cl₁—Pd—Cl₂, 174.7°) in 7a, respectively. These bonds lengths are in the range comparable to Pd(NHC)(heterocycle)Cl₂ complexes, with the corollary that the availability of anilines offers a straightforward approach to modulate the steric and electronic effect on the metal center in [(NHC)PdCl₂(aniline)] complexes.

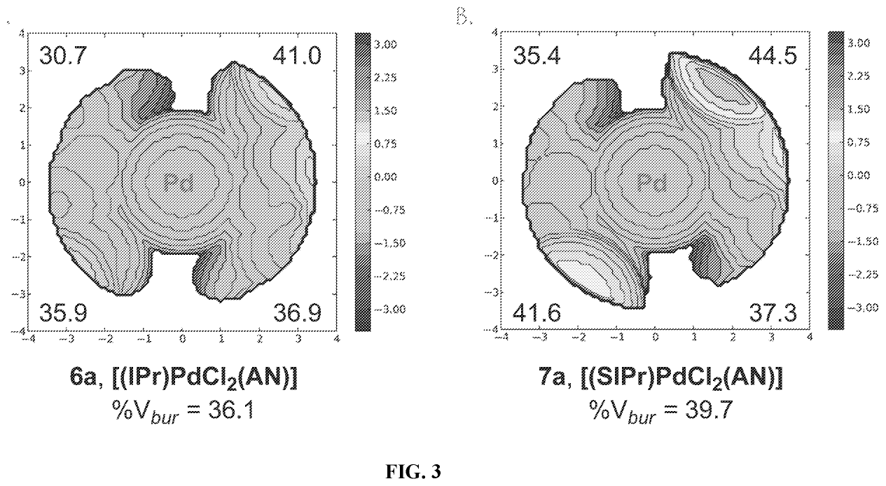

To evaluate the steric impact in [(NHC)PdCl₂(aniline)] complexes, the % buried volume (% V_{bur}) and steric maps in 6a and 7a were calculated (FIG. 3). With the (% V_{bur}) of 36.1% and 39.7% 6a and 7a represent bulky [Pd—NHC] complexes. These values can be compared with the (% V_{bur}) of 34.8% and 39.2% for [Pd(IPr)(3-Cl-py)Cl₂] and [Pd(SIPr)(3-Cl-py)Cl₂] complexes. As expected, the unsymmetrical aniline throw-away ligand leads to uneven quadrant distribution with 30.7%, 41.0%, 36.9%, 35.9% (6a) and 35.4%, 44.5%, 37.3%, 41.6% (7a) for each quadrant. The differentiated steric environment around the metal might influence substrate approach and catalyst activation in [(NHC)PdCl₂(aniline)] complexes.

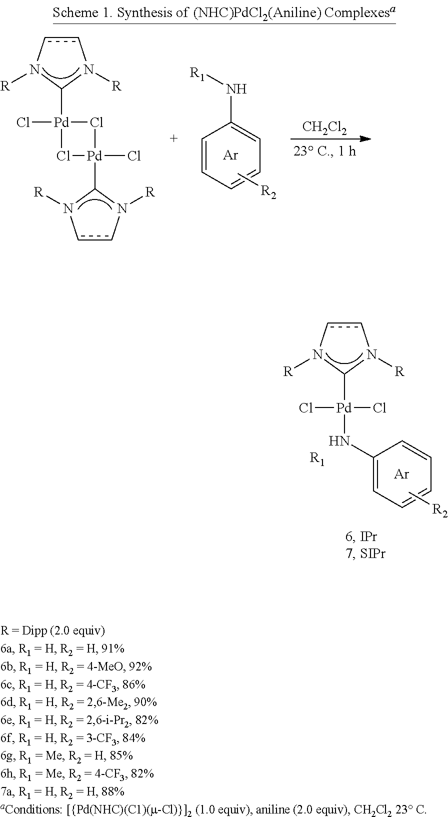

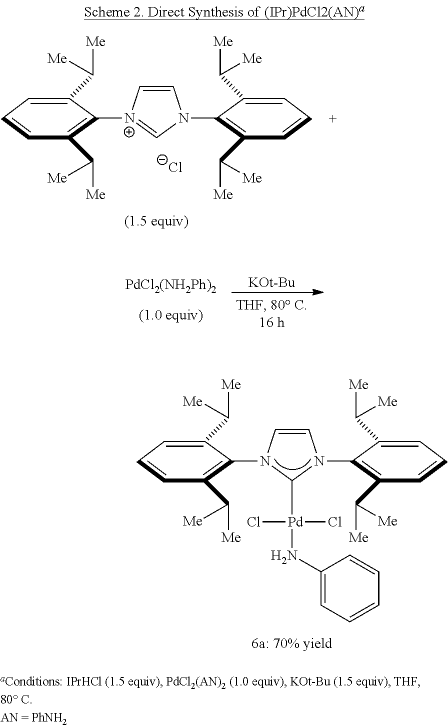

With the straightforward access to (NHC)PdCl₂(aniline) complexes, the reactivity of these new Pd(II)-NHC precatalysts was next explored. For the initial screen, the Suzuki-Miyaura cross-coupling of amides by N—C(O) activation was selected (Table 1). The reactions performed at 1.0 mol % of (IPr)PdCl₂(aniline) (K₂CO₃, H₂O, THF, 16 h) using a series of electronically- and sterically-differentiated precatalysts 6a-h demonstrate high reactivity in the cross-coupling at mild room temperature (Table 1, column A). As such, electron-neutral aniline ligand (6a), both electron-donating 4-anisidine (6b) and electron-withdrawing 4-trifluoromethylaniline (6c) and moderately sterically-hindered 2,6-xylidine (6d) all afforded the cross-coupling product in quantitative yield under these conditions. The use of a more sterically-demanding 2,6-diisopropylaniline (6e) resulted in lower efficiency in the cross-coupling. Electron-withdrawing trifluoromethyl group at the meta position (6f) as well as the use of N-Me-anilines (6g-h) and the representative NHC with a saturated backbone (SIPr)PdCl₂(AN) (7a) provided the cross-coupling product with excellent efficiency.

TABLE 1
Activity of (NHC)PdCl₂(Aniline) Complexes in the Suzuki-Miyaura Cross-
Coupling of Amides

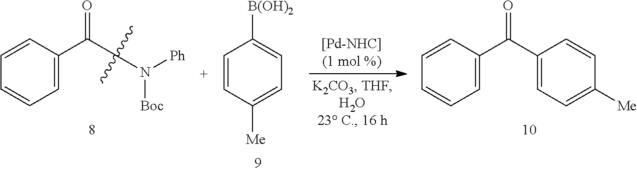

| | | | | A | B | C |
|---|---|---|---|---|---|---|
| entry | aniline | [Pd-NHC] | NHC | yield (%)^{a} | yield (%)^{b} | yield (%)^{c} |
| 1 | 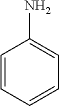 | 6a | IPr | >98 | >98 | 52 |
| 2 | 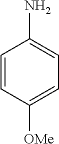 | 6b | IPr | >98 | 90 | 22 |
| 3 | 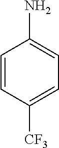 [SMILES: Nc1ccc(C(F)(F)F)cc1] | 6c | IPr | >98 | >98 | 58 |
| 4 | 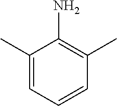 | 6d | IPr | >98 | 37 | 37 |
| 5 | 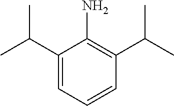 | 6e | IPr | 54 | 11 | <5 |
| 6 | 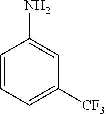 [SMILES: Nc1cccc(C(F)(F)F)c1] | 6f | IPr | >98 | >98 | 84 |
| 7 | 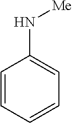 | 6g | IPr | >98 | >98 | 46 |
| 8 | 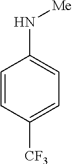 [SMILES: CNc1ccc(C(F)(F)F)cc1] | 6h | IPr | >98 | >98 | 31 |
| 9 | 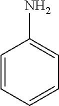 | 7a | SIPr | >98 | 62 | 8 |

^{a}[Pd] (1.0 mol %), amide (1.0 equiv), Ar—B(OH)₂ (2.0 equiv), K₂CO₃ (3.0 equiv), H₂O (5.0 equiv), THF (0.25M), 23° C., 16 h.
^{b}[Pd] (0.25 mol %).
^{c}[Pd] (1.0 mol %), 3 h.

Next, the cross-coupling was performed at 0.25 mol % loading of (IPr)PdCl₂(aniline) to differentiate the activity of these new precatalysts (Table 1, column B). In this more discriminating screen, electron-neutral (6a) and electron-withdrawing (6c) substituents are preferred over electron-donating substituents (6b), while steric hindrance on the aniline ring (6d-e) resulted in lower cross-coupling efficiency. Trifluoromethyl group at the meta position (6f) and N-Me-anilines (6g-h) performed well in this screen, while the saturated (SIPr)PdCl₂(AN) (7a) proved to be less efficient. To gain insight into the activation of these new precatalysts, the reactions were performed at 1.0 mol % of (IPr)PdCl₂(aniline) for shorter reaction time (Table 1, column C, RT, 3 h). As shown, electron-neutral (6a), electron-withdrawing (6b) and N-Me-substituted (6g) led to high reaction efficiency. Thus, the study resulted in the discovery of 3-trifluoromethylaniline (6f) as the optimal ligand, with the neutral aniline (6a) as an inexpensive variant available in bulk.

The generality of the Suzuki-Miyaura cross-coupling using (IPr)PdCl₂(AN) is shown in Table 2. As shown, the reaction was well-tolerant of the functional groups and substituents on both the boronic acid and the amide cross-coupling partner. Electron-donating, electron-withdrawing and sterically-hindered substituents were well-tolerated on both coupling partners, affording the cross-coupling products in excellent yields.

TABLE 2
[(IPr)PdCl₂(AN)]-Catalyzed Suzuki-Miyaura Cross-Coupling of Amides by
C—N Cleavage^{a}

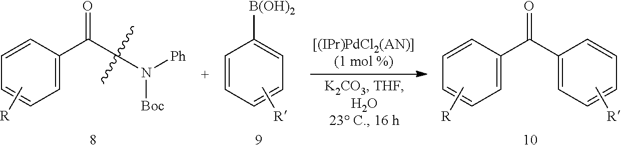

| entry | amide (Ar₁) | Ar₂—B(OH)₂ | yield (%) |
|---|---|---|---|
| 1 | Ph | R′ = 4-Me | 98 |
| 2 | Ph | R′ = 4-MeO | 95 |
| 3 | Ph | R′ = 4-CF₃ | 97 |
| 4 | Ph | R′ = 4-CO₂Me | 91 |
| 5 | Ph | R′ = 2-Me | 90 |
| 6 | 4-MeO—C₆H₄ | R′ = H | 94 |
| 7 | 4-CF₃—C₆H₄ | R′ = H | 95 |
| 8 | 2-Me—C₆H₄ | R′ = H | 79 |

^{a}Conditions: [Pd] (1.0 mol %), amide (1.0 equiv), Ar—B(OH)₂ (2.0 equiv), K₂CO₃ (3.0 equiv), H₂O (5.0 equiv), THF (0.25M), 23° C., 16 h.

The Suzuki-Miyaura cross-coupling of esters by C—O activation is also feasible using this new catalyst system (Scheme 3). In some embodiments, the Pd—NHC catalyst bearing 3-trifluoromethylaniline (6f) is more efficient than the neutral aniline (6a) ligand in this more challenging C—O cross-coupling, mirroring the reactivity trend observed in the amide C—N bond activation. To extend the utility of (NHC)PdCl₂(aniline) complexes, the reactivity of (IPr)PdCl₂(AN) in the Suzuki-Miyaura cross-coupling of aryl chlorides (Scheme 4, and Table 3) was investigated. As shown, the reaction displayed excellent tolerance. Aryl chlorides substituted with electron-donating, electron-withdrawing and sterically-hindered functional groups as well as boronic acids bearing electron-donating, electron-withdrawing and sterically-hindered substituents provided the cross-coupling products in excellent yields.

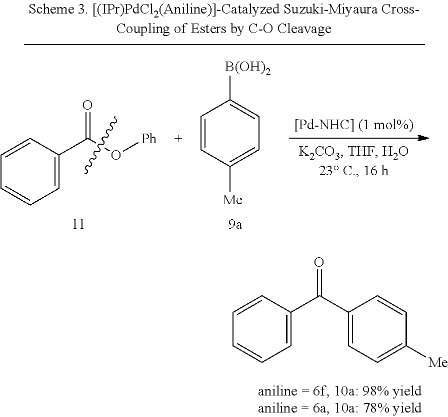

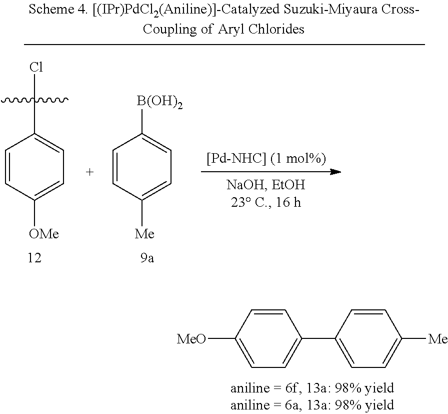

TABLE 3
[(IPr)PdCl₂(AN)]-Catalyzed Suzuki-Miyaura Cross-Coupling of Aryl
Chlorides^{a}

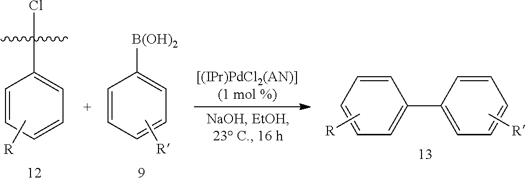

| entry | aryl chloride (Ar₁) | Ar₂—B(OH)₂ | yield (%) |
|---|---|---|---|
| 1 | 4-MeO—C₆H₄ | R′ = 4-Me | 98 |
| 2 | 4-MeO—C₆H₄ | R′ = H | 98 |
| 3 | 4-CF₃—C₆H₄ | R′ = H | 98 |
| 4 | 4-CN—C₆H₄ | R′ = H | 88 |
| 5 | 4-COMe—C₆H₄ | R′ = H | 98 |
| 6 | 2-C₅H₄N | R′ = H | 89 |
| 7 | 2-Me—C₆H₄ | R′ = H | 90 |
| 8 | Ph | R′ = 4-MeO | 98 |
| 9 | Ph | R′ = 4-CF₃ | 93 |
| 10 | Ph | R′ = 4-COMe | 94 |
| 11 | Ph | R′ = 2-Me | 87 |
| 12 | 2-Me—C₆H₄ | R′ = 2-Me | 78 |

^{a}Conditions: [Pd] (1.0 mol %), aryl chloride (1.0 equiv), Ar—B(OH)₂ (2.0 equiv), NaOH (2.0 equiv), EtOH (0.25M), 23° C., 16 h.

The utility of (NHC)PdCl₂(aniline) complexes were evaluated in the Buchwald-Hartwig cross-coupling of aryl chlorides (Scheme 5). Thus, Pd—NHC catalysts bearing neutral aniline (6a) and 3-trifluoromethylaniline (6f) promoted the cross-coupling in excellent yield.

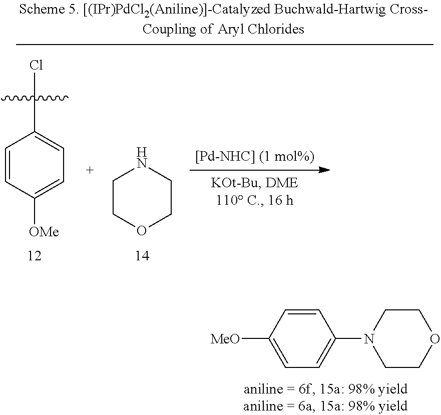

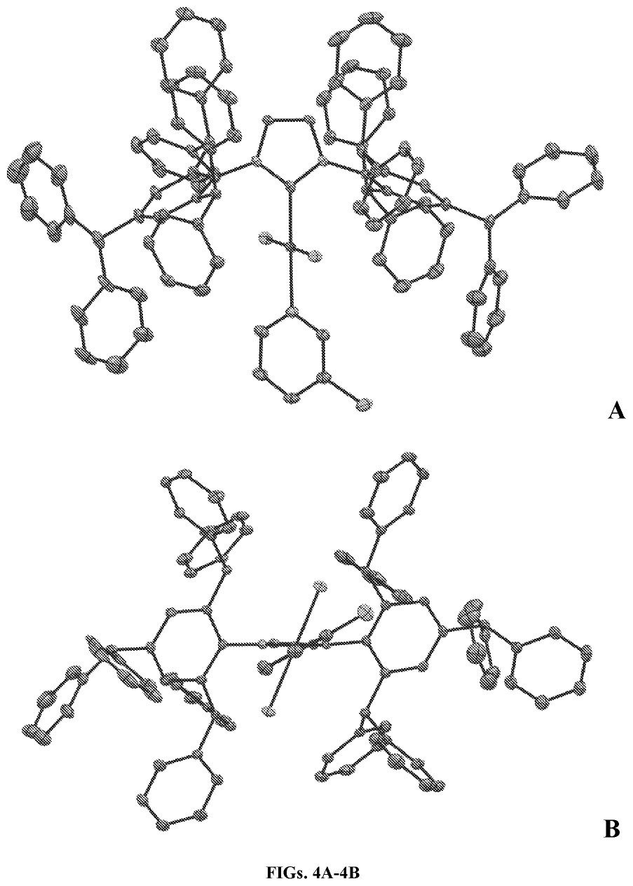

To gain insight into the properties of these novel (NHC)PdCl₂(aniline) complexes, HOMO and LUMO energy levels of the representative (IPr)PdCl₂(AN) (6a) were determined at the B3LYP 6-311++g(d,p) level of theory (FIG. 4). Computational evaluation of the ground-state properties based on x-ray determined solid state structures provides a powerful approach to predict reactivity of metal-NHC complexes. Determination of HOMO (−6.08 eV) and LUMO (−1.76 eV) of (6a) shows that HOMO is located on palladium, while the LUMO is located on the carbene ligand, chlorides, and the throw-away ligand. This can be compared with the analogous Pd-PEPPSI system (−6.06 eV; −1.88 eV) and imidazolinylidene system (7a) (−6.07 eV; −1.75 eV). To further understand properties of the Pd—C(carbene) bond in (NHC)PdCl₂(aniline) complexes, we performed NBO analysis. The Wiberg bond orders for the Pd—C(carbene) and Pd—N bonds in (6a) are 0.6776 and 0.3142 (Pd—C₁, 0.6299; Pd—Cl₂, 0.6305), which can be compared with the analogous [Pd(IPr)(3-Cl-py)Cl₂] system (Pd—C, 0.6871; Pd—N, 0.6302; Pd—Cl₁, 0.6302; Pd—Cl₂, 0.6278) and imidazolinylidene system (7a) (Pd—C, 0.6745; Pd—N, 0.3024). The computational studies suggest that aniline ligands are well-applicable to change the electron density along the metal-NHC axis.

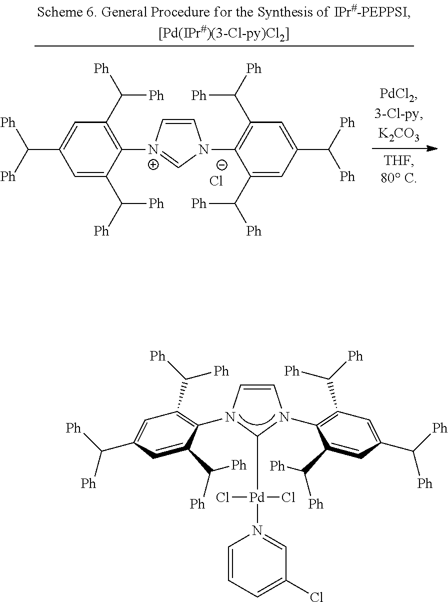

An oven-dried flask equipped with a stir bar was charged with IPr #HCl (552 mg, 0.44 mmol, 1.1 equiv), PdCl₂ (71 mg, 0.4 mmol, 1.0 equiv) and K₂CO₃ (276 mg, 2.0 mmol, 5.0 equiv), placed under a positive pressure of argon and subjected to three evacuation/backfilling cycles under high vacuum. 3-chloropyridine (2.0 mL) was added, and the reaction mixture was stirred at 80° C. for 24 h. After the indicated time, the reaction was cooled down to room temperature, diluted with CH₂Cl₂ and filtered. The solution was collected and concentrated. The product was obtained by trituration from CH₂Cl₂/hexanes as a white solid. Yield 82% (494 mg). ¹H NMR (500 MHz, CDCl₃) δ 8.97 (s, 1H), 8.81 (d, J=5.5 Hz, 1H), 7.83 (d, J=8.2 Hz, 1H), 7.27 (m, 8H), 7.15 (m, 12H), 7.10-7.05 (m, 16H), 7.00 (dd, J=19.7, 7.4 Hz, 16H), 6.78 (s, 4H), 6.69 (d, J=7.5 Hz, 8H), 6.32 (s, 4H), 5.38 (s, 2H), 4.98 (s, 2H). ¹³C NMR (125 MHz, CDCl₃) δ 150.85, 149.93, 144.16, 144.04, 143.61, 141.79, 138.01, 135.88, 132.61, 131.42, 130.27, 129.47, 129.36, 128.27, 127.83, 126.23, 126.14, 126.06, 124.81, 124.14, 56.30, 51.09. HRMS calcd for C₉₈H₇₆N₃Cl₂Pd (M⁺−Cl) 1472.4452, found 1472.4450. The structure was confirmed by the X-ray crystallography.

TABLE 4
Activity of IPr^{#}-PEPPSI, [Pd(IPr^{#})(3-Cl-py)Cl₂], in Cross-Coupling Reactions

| | |
|---|---|
| 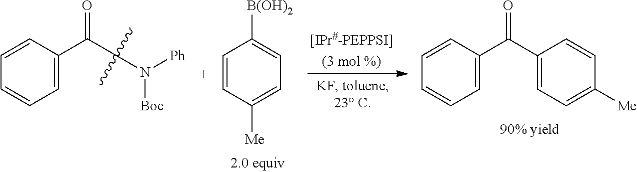 | (1) |
| 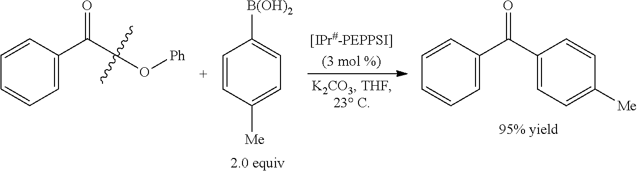 | (2) |
| 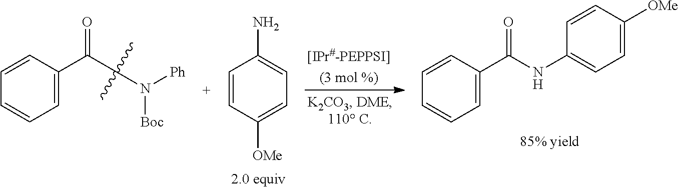 | (3) |
| 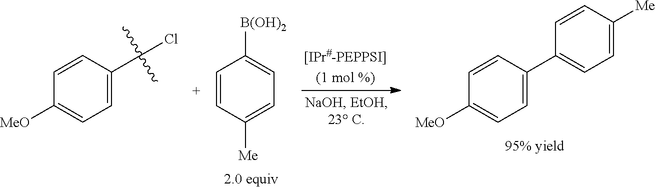 | (4) |
| 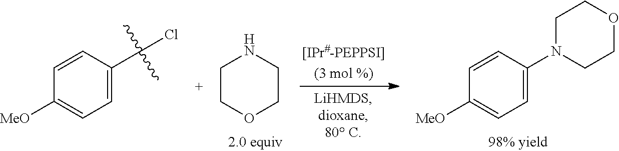 | (5) |
| 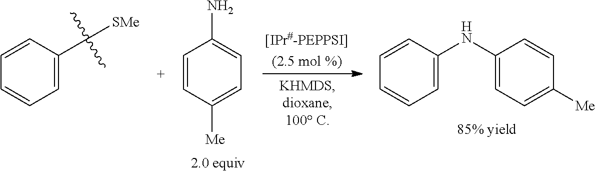 | (6) |
| 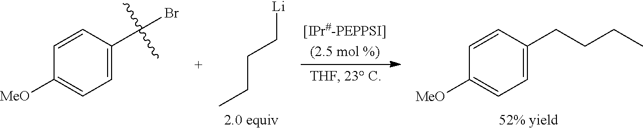 | (7) |
| 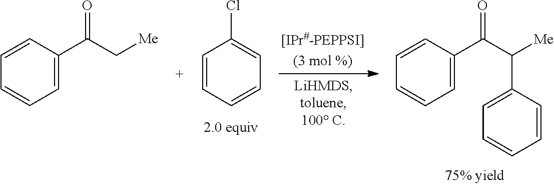 [SMILES: CCC(=O)c1ccccc1 ; Clc1ccccc1 ; CC(C(=O)c1ccccc1)c1ccccc1] | (8) |
| 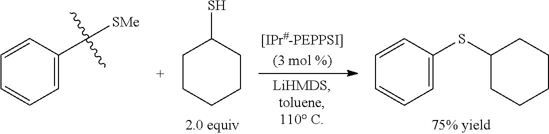 | (9) |
| 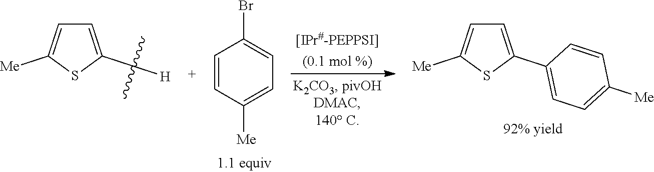 | (10) |

The terms and expressions employed herein are used as terms of description and not of limitation, and there is no intention in the use of such terms and expressions of excluding any equivalents of the features shown and described or portions thereof, but it is recognized that various modifications are possible within the scope of the embodiments of the present application. Thus, it should be understood that although the present application describes specific embodiments and optional features, modification and variation of the compositions, methods, and concepts herein disclosed may be resorted to by those of ordinary skill in the art, and that such modifications and variations are considered to be within the scope of embodiments of the present application.

### Enumerated Embodiments

The following exemplary embodiments are provided, the numbering of which is not to be construed as designating levels of importance:

Embodiment 1 provides a compound of Formula I, or a salt, solvate, geometric isomer, or stereoisomer thereof:

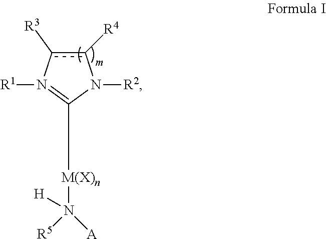

wherein: [symbol] is a single or double bond; R¹ and R² are each independently C₃₋₁₀ cycloalkyl, aryl, or heteroaryl, each of which is optionally substituted by at least one group selected from the group consisting of halogen, OR, SiR₃, OSiR₃, OSiR₃, OSi(OR)₃, BR₃, BR₂, B(OR)₃, B(OR)₂, CN, CF₃, OCF₃, SO₂R, SO₂N(R)₂, SO₃R, C(O)R, NR₂, N(R)SO₂R, N(R)SO₂N(R)₂, (CH₂)₀₋₂N(R)C(O)R, (CH₂)₀₋₂N(R)N(R)₂, N(R)C(O)OR, C₁₋₁₂ alkyl, C₁₋₁₂ heteroalkyl, OC₁₋₁₂ alkyl, C₃₋₁₂ cycloalkyl, C₆₋₁₀ aryl, and C₆₋₁₀ heteroaryl; R³ and R⁴ are each independently hydrogen, optionally substituted C₃₋₁₀ cycloalkyl, optionally substituted aryl, optionally substituted heteroaryl, C₁₋₁₂ alkyl, or OC₁₋₁₂ alkyl, wherein the optional substitution comprises at least one group selected from the group consisting of halogen, OR, SiR₃, OSiR₃, OSiR₃, OSi(OR)₃, BR₃, BR₂, B(OR)₃, B(OR)₂, CN, CF₃, OCF₃, SO₂R, SO₂N(R)₂, SO₃R, C(O)R, NR₂, N(R)SO₂R, N(R)SO₂N(R)₂, (CH₂)₀₋₂N(R)C(O)R, (CH₂)₀₋₂N(R)N(R)₂, N(R)C(O)OR, C₁₋₁₂ alkyl, C₁₋₁₂ heteroalkyl, OC₁₋₁₂ alkyl, C₃₋₁₂ cycloalkyl, C₆₋₁₀ aryl, and C₆₋₁₀ heteroaryl; or R³ and R⁴ taken together with the ring to which they are attached are used to form a C₄₋₂₀ cycloalkyl, C₆₋₂₀ aryl, or C₆₋₂₀ heteroaryl, each of which is optionally substituted by at least one group selected from the group consisting of halogen, OR, SiR₃, OSiR₃, OSiR₃, OSi(OR)₃, BR₃, BR₂, B(OR)₃, B(OR)₂, CN, CF₃, OCF₃, SO₂R, SO₂N(R)₂, SO₃R, C(O)R, NR₂, N(R)SO₂R, N(R)SO₂N(R)₂, (CH₂)₀₋₂N(R)C(O)R, (CH₂)₀₋₂N(R)N(R)₂, N(R)C(O)OR, C₁₋₁₂ alkyl, C₁₋₁₂ heteroalkyl, OC₁₋₁₂ alkyl, C₃₋₁₂ cycloalkyl, C₆₋₁₀ aryl, and C₆₋₁₀ heteroaryl; R⁵ is H or C₁₋₃ alkyl; M is a transition metal; X is a counter anion; A is C₆₋₁₈ aryl or C₆₋₁₈ heteroaryl optionally substituted by at least one group selected from the group consisting of halogen, OR, SiR₃, OSiR₃, OSiR₃, OSi(OR)₃, BR₃, BR₂, B(OR)₃, B(OR)₂, CN, CF₃, OCF₃, SO₂R, SO₂N(R)₂, SO₃R, C(O)R, NR₂, N(R)SO₂R, N(R)SO₂N(R)₂, (CH₂)₀₋₂N(R)C(O)R, (CH₂)₀₋₂N(R)N(R)₂, N(R)C(O)OR, C₁₋₁₂ alkyl, C₁₋₁₂ heteroalkyl, OC₁₋₁₂ alkyl, C₃₋₁₂ cycloalkyl, C₆₋₁₀ aryl, and C₆₋₁₀ heteroaryl; R is independently at each occurrence hydrogen or optionally substituted C₁₋₁₀ alkyl; m is 1, 2, or 3; and n is 1, 2, 3, or 4.

Embodiment 2 provides the compound of Embodiment 1, having the structure:

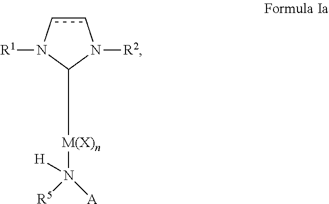

or a salt, solvate, geometric isomer, or stereoisomer thereof.

Embodiment 3 provides the compound of any of Embodiments 1-2, wherein R¹ and R² are both aryl.

Embodiment 4 provides the compound of any of Embodiments 1-3, wherein the aryl is:

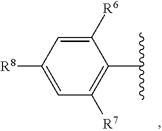

wherein: R⁶ and R⁷ are each independently C₁₋₁₂ alkyl or C₁₋₁₂ alkyl substituted by at least one aryl; and R⁸ is hydrogen or C₁₋₁₂ alkyl or C₁₋₁₂ alkyl substituted by at least one aryl.

Embodiment 5 provides the compound of any of Embodiments 1-4, wherein R⁸ is hydrogen.

Embodiment 6 provides the compound of any of Embodiments 1-5, wherein R⁶ and R⁷ are each C₁₋₆ alkyl.

Embodiment 7 provides the compound of any of Embodiments 1-6, wherein R⁶ and R⁷ are each C(H)(CH₃)₂.

Embodiment 8 provides the compound of any of Embodiments 1-7, wherein M is selected from the group consisting of Fe, Co, Ni, Cu, Ru, Rh, Pd, Ag, Re, Os, Ir, Pt, and Au.

Embodiment 9 provides the compound of any of Embodiments 1-8, wherein M is Pd.

Embodiment 10 provides the compound of any of Embodiments 1-9, wherein X is selected from the group consisting of F, Cl, Br, I, OSO₂R, OSO₃R, and OC(═O)R.

Embodiment 11 provides the compound of any of Embodiments 1-10, wherein the N-heterocyclic carbene (NHC) moiety of the compound of Formula I is selected from the group consisting of:

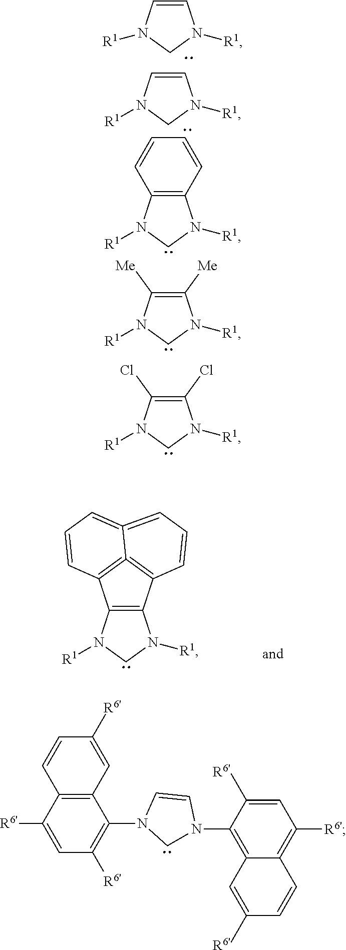

wherein
R¹ is selected from the group consisting of t-Bu, 1-adamantyl, cyclohexyl, i-Pr, methyl, ethyl, n-propyl, butyl, pentyl, and

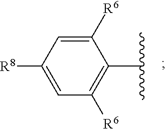

R⁶ is CH(phenyl)₂, CH(Me)₂, CH(2-Np)₂, or CH(Et)₂;
R^{6′} is CH(phenyl)₂, CH(Me)₂, or CH(Et); and
R⁸ is CH(phenyl)₂, Me, OMe, or H.

Embodiment 12 provides the compound of any of Embodiments 1-11, wherein the NHC moiety of the compound of Formula I is selected from the group consisting of

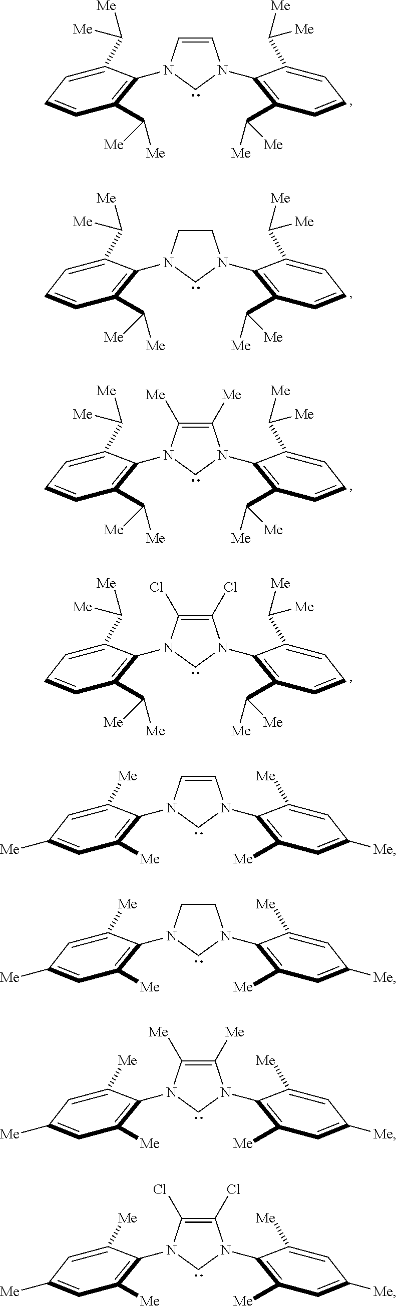

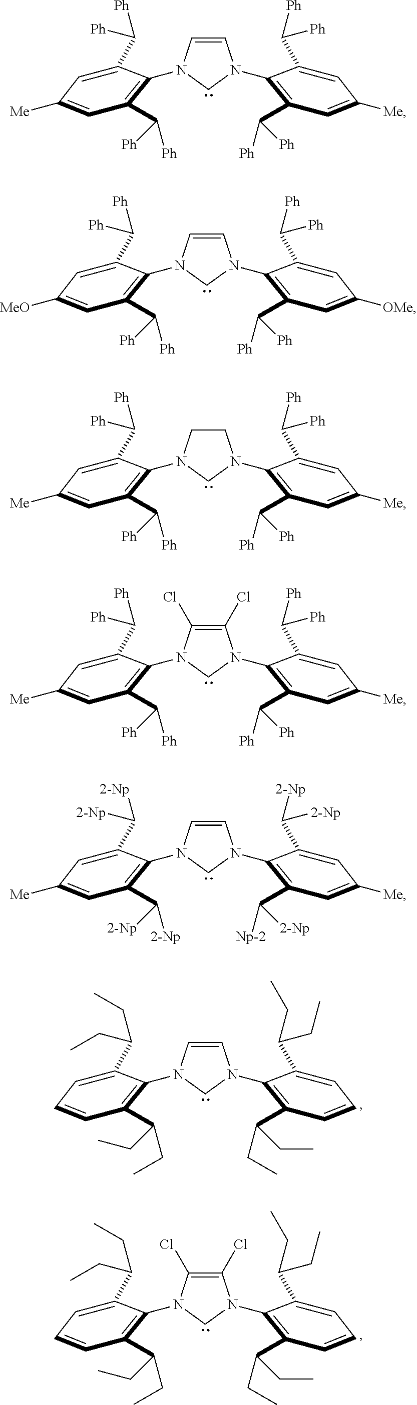

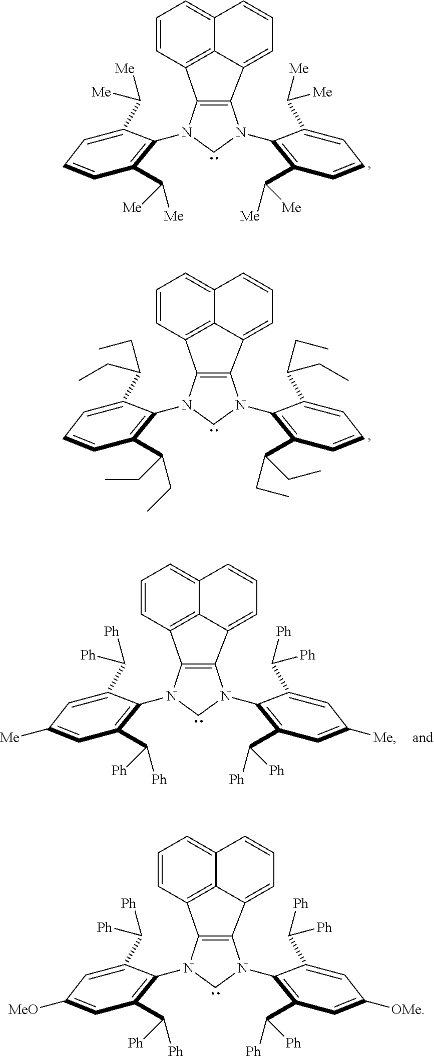

Embodiment 13 provides the compound of any of Embodiments 1-12, wherein n is 2.

Embodiment 14 provides the compound of any of Embodiments 1-13, wherein A is

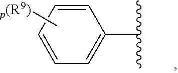

and wherein each occurrence of R⁹ is independently selected from the group consisting of OCH₃, CF₃, 2,6-dimethyl, 2,6-di-isopropyl, and hydrogen, and wherein p is 0, 1, 2, 3, 4, or 5.

Embodiment 15 provides the compound of any of Embodiments 1-14, wherein R⁵ is hydrogen or methyl.

Embodiment 16 provides a method of making the compound of any of Embodiments 1-15, the method comprising: contacting a compound with the structure

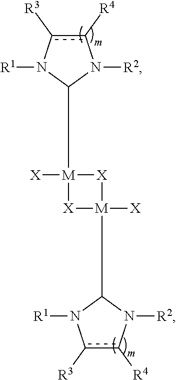

or a salt, solvate, geometric isomer, or stereoisomer thereof, with a compound with the structure of

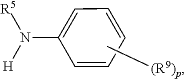

or a salt, solvate, geometric isomer, or stereoisomer thereof, in a solvent to form a compound of Formula I, wherein each occurrence of R⁹ is independently selected from the group consisting of hydrogen halogen, OR, SiR₃, OSiR₃, OSiR₃, OSi(OR)₃, BR₃, BR₂, B(OR)₃, B(OR)₂, CN, CF₃, OCF₃, SO₂R, SO₂N(R)₂, SO₃R, C(O)R, NR₂, N(R)SO₂R, N(R)SO₂N(R)₂, (CH₂)₀₋₂N(R)C(O)R, (CH₂)₀₋₂N(R)N(R)₂, N(R)C(O)OR, C₁₋₁₂ alkyl, C₁₋₁₂ heteroalkyl, OC₁₋₁₂ alkyl, C₃₋₁₂ cycloalkyl, C₆₋₁₀ aryl, and C₆₋₁₀ heteroaryl.

Embodiment 17 provides the method of Embodiment 16, wherein the solvent is a non-polar aprotic solvent.

Embodiment 18 provides the method of any of Embodiments 16-17, wherein the solvent comprises chloroform, diethyl ether, deuterated chloroform, pentane, hexanes, benzene, toluene, dichloromethane, or mixtures thereof.

Embodiment 19 provides the method of any of Embodiments 16-18, wherein the contacting is performed at room temperature.

Embodiment 20 provides a method of making the compound of any of Embodiments 1-15, the method comprising: contacting a compound with the structure

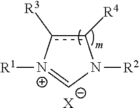

or a salt, solvate, geometric isomer, or stereoisomer thereof, with a compound of formula MX₂(A-N(H)(R⁵))₂, or a salt, solvate, geometric isomer, or stereoisomer thereof, in a solvent to form the compound of Formula I, or a salt, solvate, geometric isomer, or stereoisomer thereof.

Embodiment 21 provides the method of Embodiment 20, wherein contacting is in the presence of a base.

Embodiment 22 provides the method of any of Embodiments 20-21, wherein the base comprises NaOC₁₋₄ alkyl, KOC₁₋₄ alkyl, lithium diisopropylamide, sodium hexamethyldisilazide, LiC₁₋₄ alkyl, or combinations thereof.

Embodiment 23 provides the method of any of Embodiments 20-22, wherein the solvent comprises a polar aprotic solvent.

Embodiment 24 provides the method of any of Embodiments 20-23, wherein the solvent comprises tetrahydrofuran, 2-N-methylpyrrolidone, dimethyl formamide, acetonitrile, and combinations thereof.

Embodiment 25 provides a compound of Formula II, or a salt, solvate, geometric isomer, or stereoisomer thereof:

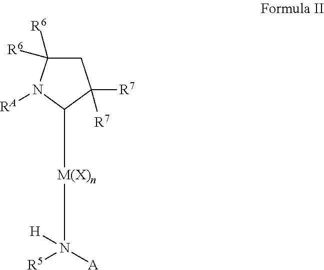

wherein: R⁵ is H or C₁₋₃ alkyl; R^{A}, R⁶ and R⁷ is independently chosen from optionally substituted C₁₋₁₂ alkyl, optionally substituted C₁₋₁₂ heteroalkyl, optionally substituted OC₁₋₁₂ alkyl, optionally substituted C₃₋₁₂ cycloalkyl, optionally substituted C₆₋₁₈ aryl, optionally substituted C₆₋₁₈ heteroaryl, and C₁₋₃ alkyl substituted with at least one aryl or heteroaryl, wherein the optional substitution is by at least one group selected from the group consisting of halogen, OR, SiR₃, OSiR₃, OSiR₃, OSi(OR)₃, BR₃, BR₂, B(OR)₃, B(OR)₂, CN, CF₃, OCF₃, SO₂R, SO₂N(R)₂, SO₃R, C(O)R, NR₂, N(R)SO₂R, N(R)SO₂N(R)₂, (CH₂)₀₋₂N(R)C(O)R, (CH₂)₀₋₂N(R)N(R)₂, N(R)C(O)OR, C₁₋₁₂ alkyl, C₁₋₁₂ heteroalkyl, OC₁₋₁₂ alkyl, C₃₋₁₂ cycloalkyl, C₆₋₁₀ aryl, and C₆₋₁₀ heteroaryl; M is a transition metal; X is a counter anion; n is an integer from 1 to 4; and R is independently at each occurrence hydrogen or optionally substituted C₁₋₁₀ alkyl.

Embodiment 26 provides a compound of Formula III, or a salt, solvate, geometric isomer, or stereoisomer thereof:

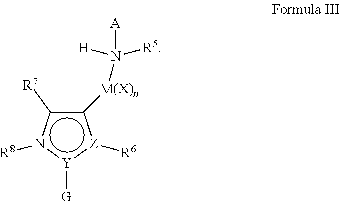

wherein: R⁵ is H or optionally substituted C₁₋₃ alkyl; R⁶, R⁷ and R⁸ is independently chosen from optionally substituted C₁₋₁₂ alkyl, optionally substituted C₁₋₁₂ heteroalkyl, optionally substituted OC₁₋₁₂ alkyl, optionally substituted C₃₋₁₂ cycloalkyl, optionally substituted C₆₋₁₈ aryl, optionally substituted C₆₋₁₈ heteroaryl, or C₁₋₃ alkyl substituted with at least one aryl or heteroaryl, wherein the optional substitution is by at least one group selected from the group consisting of halogen, OR, SiR₃, OSiR₃, OSiR₃, OSi(OR)₃, BR₃, BR₂, B(OR)₃, B(OR)₂, CN, CF₃, OCF₃, SO₂R, SO₂N(R)₂, SO₃R, C(O)R, NR₂, N(R)SO₂R, N(R)SO₂N(R)₂, (CH₂)₀₋₂N(R)C(O)R, (CH₂)₀₋₂N(R)N(R)₂, N(R)C(O)OR, C₁₋₁₂ alkyl, C₁₋₁₂ heteroalkyl, OC₁₋₁₂ alkyl, C₃₋₁₂ cycloalkyl, C₆₋₁₀ aryl, and C₆₋₁₀ heteroaryl; G is absent, optionally substituted C₁₋₁₂ alkyl, optionally substituted C₁₋₁₂ heteroalkyl, optionally substituted OC₁₋₁₂ alkyl, optionally substituted C₃₋₁₂ cycloalkyl, optionally substituted C₆₋₁₈ aryl, optionally substituted C₆₋₁₈ heteroaryl, or C₁₋₃ alkyl substituted with at least one aryl or heteroaryl, wherein the optional substitution is by at least one group selected from the group consisting of halogen, OR, SiR₃, OSiR₃, OSiR₃, OSi(OR)₃, BR₃, BR₂, B(OR)₃, B(OR)₂, CN, CF₃, OCF₃, SO₂R, SO₂N(R)₂, SO₃R, C(O)R, NR₂, N(R)SO₂R, N(R)SO₂N(R)₂, (CH₂)₀₋₂N(R)C(O)R, (CH₂)₀₋₂N(R)N(R)₂, N(R)C(O)OR, C₁₋₁₂ alkyl, C₁₋₁₂ heteroalkyl, OC₁₋₁₂ alkyl, C₃₋₁₂ cycloalkyl, C₆₋₁₀ aryl, and C₆₋₁₀ heteroaryl; M is a transition metal; X is a counter anion; Y is N or C; Z is N or C; n is an integer from 1 to 4; and R is independently at each occurrence hydrogen or optionally substituted C₁₋₁₀ alkyl, with the proviso that Y and Z are not both C.

1. A compound of Formula I, or a salt, solvate, geometric isomer, or stereoisomer thereof: 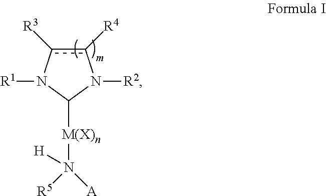
wherein: [symbol]
is a single or double bond;
R¹ and R² are each independently C₃₋₁₀ cycloalkyl, aryl, or heteroaryl, each of which is optionally substituted with at least one group selected from the group consisting of halogen, OR, SiR₃, OSiR₃, OSiR₃, OSi(OR)₃, BR₃, BR₂, B(OR)₃, B(OR)₂, CN, CF₃, OCF₃, SO₂R, SO₂N(R)₂, SO₃R, C(O)R, NR₂, N(R)SO₂R, N(R)SO₂N(R)₂, (CH₂)₀₋₂N(R)C(O)R, (CH₂)₀₋₂N(R)N(R)₂, N(R)C(O)OR, C₁₋₁₂ alkyl, C₁₋₁₂ heteroalkyl, OC₁₋₁₂ alkyl, C₃₋₁₂ cycloalkyl, C₆₋₁₀ aryl, and C₆₋₁₀ heteroaryl;
R³ and R⁴ are each independently hydrogen, optionally substituted C₃₋₁₀ cycloalkyl, optionally substituted aryl, optionally substituted heteroaryl, C₁₋₁₂ alkyl, or OC₁₋₁₂ alkyl,
wherein the optional substitution comprises at least one group selected from the group consisting of halogen, OR, SiR₃, OSiR₃, OSiR₃, OSi(OR)₃, BR₃, BR₂, B(OR)₃, B(OR)₂, CN, CF₃, OCF₃, SO₂R, SO₂N(R)₂, SO₃R, C(O)R, NR₂, N(R)SO₂R, N(R)SO₂N(R)₂, (CH₂)₀₋₂N(R)C(O)R, (CH₂)₀₋₂N(R)N(R)₂, N(R)C(O)OR, C₁₋₁₂ alkyl, C₁₋₁₂ heteroalkyl, OC₁₋₁₂ alkyl, C₃₋₁₂ cycloalkyl, C₆₋₁₀ aryl, and C₆₋₁₀ heteroaryl; or
R³ and R⁴ taken together with the ring to which they are attached are used to form a C₄₋₂₀ cycloalkyl, C₆₋₂₀ aryl, or C₆₋₂₀ heteroaryl,
each of which is optionally substituted by at least one group selected from the group consisting of halogen, OR, SiR₃, OSiR₃, OSiR₃, OSi(OR)₃, BR₃, BR₂, B(OR)₃, B(OR)₂, CN, CF₃, OCF₃, SO₂R, SO₂N(R)₂, SO₃R, C(O)R, NR₂, N(R)SO₂R, N(R)SO₂N(R)₂, (CH₂)₀₋₂N(R)C(O)R, (CH₂)₀₋₂N(R)N(R)₂, N(R)C(O)OR, C₁₋₁₂ alkyl, C₁₋₁₂ heteroalkyl, OC₁₋₁₂ alkyl, C₃₋₁₂ cycloalkyl, C₆₋₁₀ aryl, and C₆₋₁₀ heteroaryl;
R⁵ is H or optionally substituted C₁₋₃ alkyl;
M is a transition metal;
X is a counter anion;
A is C₆₋₁₈ aryl or C₆₋₁₈ heteroaryl optionally substituted with at least one group selected from the group consisting of halogen, OR, SiR₃, OSiR₃, OSiR₃, OSi(OR)₃, BR₃, BR₂, B(OR)₃, B(OR)₂, CN, CF₃, OCF₃, SO₂R, SO₂N(R)₂, SO₃R, C(O)R, NR₂, N(R)SO₂R, N(R)SO₂N(R)₂, (CH₂)₀₋₂N(R)C(O)R, (CH₂)₀₋₂N(R)N(R)₂, N(R)C(O)OR, C₁₋₁₂ alkyl, C₁₋₁₂ heteroalkyl, OC₁₋₁₂ alkyl, C₃₋₁₂ cycloalkyl, C₆₋₁₀ aryl, and C₆₋₁₀ heteroaryl;
R is independently at each occurrence hydrogen or optionally substituted C₁₋₁₀ alkyl;
m is 1, 2, or 3; and
n is 1, 2, 3, or 4.

2. The compound of claim 1, which is a compound of Formula Ia: 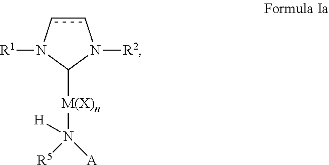
or a salt, solvate, geometric isomer, or stereoisomer thereof.

3. The compound of claim 1, wherein R¹ and R² are both aryl.

4. The compound of claim 3, wherein the aryl is: 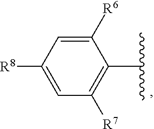
wherein:
R⁶ and R⁷ are each independently C₁₋₁₂ alkyl or C₁₋₁₂ alkyl substituted with by at least one aryl; and
R⁸ is hydrogen, C₁₋₁₂ alkyl, or C₁₋₁₂ alkyl substituted by at least one aryl.

5. The compound of claim 4, wherein at least one of the following applies:
(a) R⁸ is hydrogen; and
(b) R⁶ and R⁷ are each C₁₋₆ alkyl.

6. (canceled)

7. The compound of claim 5, wherein R⁶ and R⁷ are each C(H)(CH₃)₂.

8. The compound of claim 1, wherein M is selected from the group consisting of Fe, Co, Ni, Cu, Ru, Rh, Pd, Ag, Re, Os, Ir, Pt, and Au.

9. The compound of claim 8, wherein M is Pd.

10. The compound of claim 1, wherein X is selected from the group consisting of F, Cl, Br, I, OSO₂R, OSO₃R, and OC(═O)R.

11. The compound of claim 10, wherein the N-heterocyclic carbene (NHC) moiety of the compound of Formula I is selected from the group consisting of: 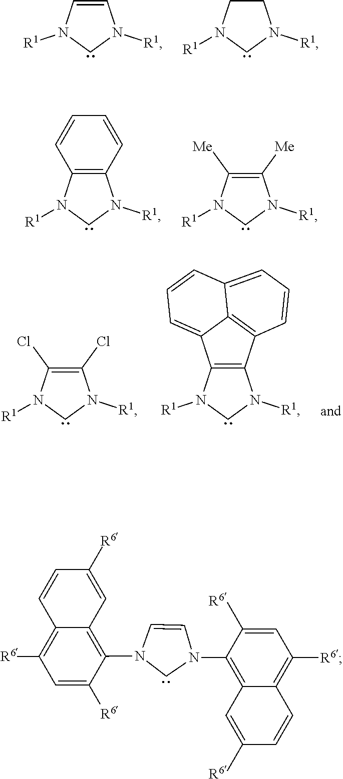
wherein:
R¹ is selected from the group consisting of t-Bu, 1-adamantyl, cyclohexyl, i-Pr, methyl, ethyl, n-propyl, butyl, pentyl, and 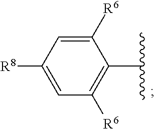
R⁶ is CH(phenyl)₂, CH(Me)₂, CH(2-Np)₂, or CH(Et)₂;
R^{6′} is CH(phenyl)₂, CH(Me)₂, or CH(Et); and
R⁸ is CH(phenyl)₂, Me, OMe, or H.

12. The compound of claim 1, wherein the NHC moiety of the compound of Formula I is selected from the group consisting of: 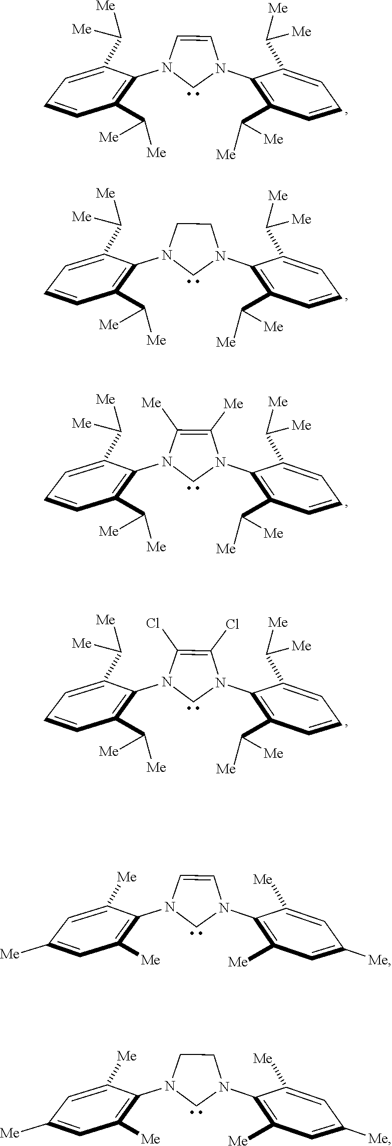 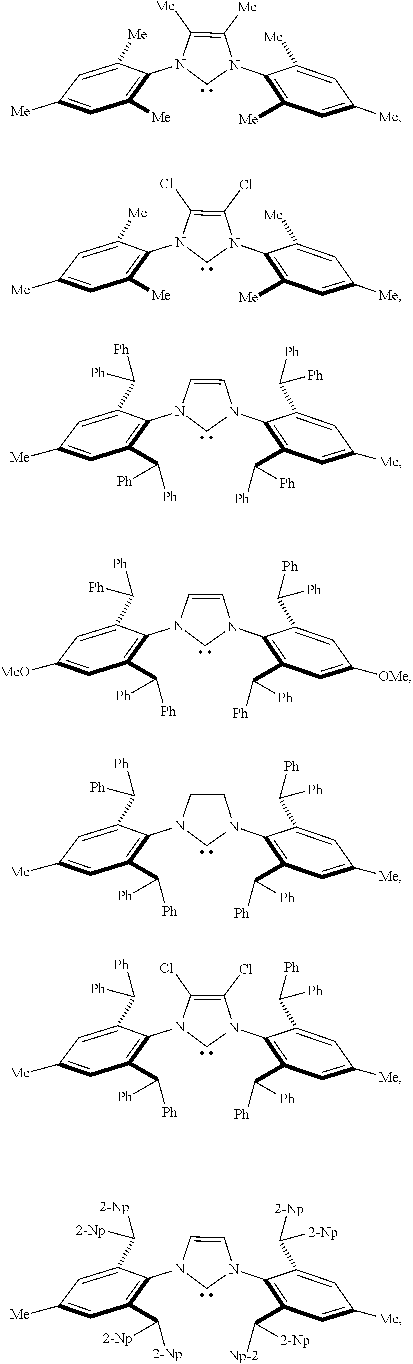 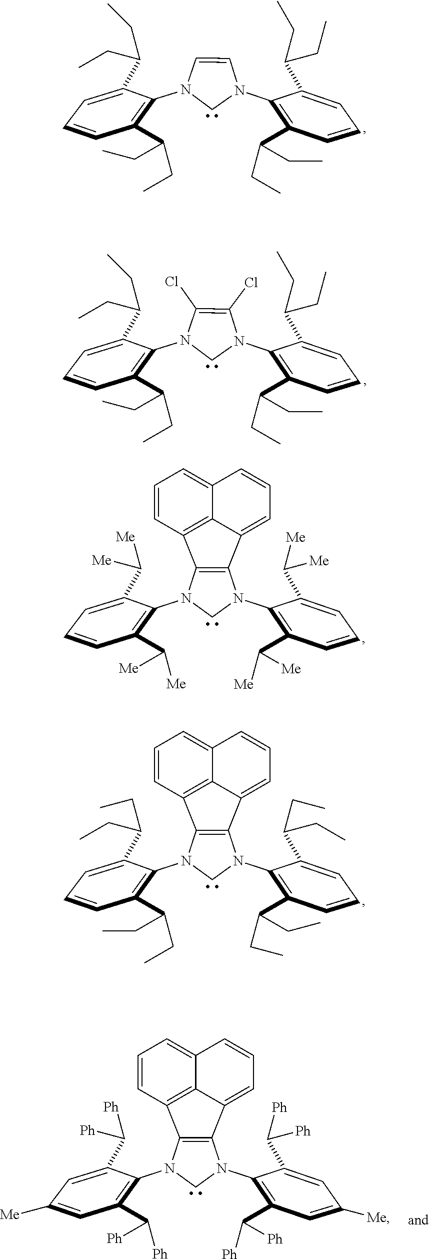 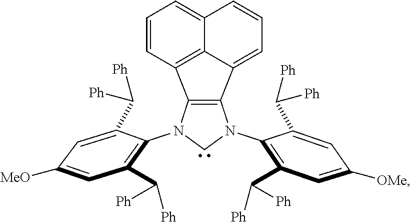
wherein 2-Np is 2-napthyl.

13. The compound of claim 1, wherein n is 2.

14. The compound of claim 1, wherein A is 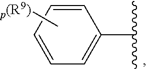
and
wherein:
each occurrence of R⁹ is independently selected from the group consisting of OCH₃, CF₃, 2,6-dimethyl, 2,6-di-isopropyl, and hydrogen; and
p is 0, 1, 2, 3, 4, or 5.

15. The compound of claim 1, wherein R⁵ is hydrogen or methyl.

16. A method of making the compound of claim 1, the method comprising:
contacting a compound with the structure: 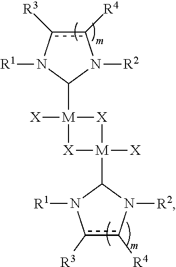
or a salt, solvate, geometric isomer, or stereoisomer thereof,
with a compound with the structure of: 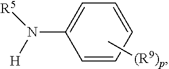
or a salt, solvate, geometric isomer, or stereoisomer thereof,
in a solvent to form a compound of Formula I, or a salt, solvate, geometric isomer, or stereoisomer thereof,
wherein each occurrence of R⁹ is independently selected from the group consisting of hydrogen, halogen, OR, SiR₃, OSiR₃, OSiR₃, OSi(OR)₃, BR₃, BR₂, B(OR)₃, B(OR)₂, CN, CF₃, OCF₃, SO₂R, SO₂N(R)₂, SO₃R, C(O)R, NR₂, N(R)SO₂R, N(R)SO₂N(R)₂, (CH₂)₀₋₂N(R)C(O)R, (CH₂)₀₋₂N(R)N(R)₂, N(R)C(O)OR, C₁₋₁₂ alkylalkyl, C₁₋₁₂ heteroalkyl, OC₁₋₁₂ alkyl, C₃₋₁₂ cycloalkyl, C₆₋₁₀ aryl, and C₆₋₁₀ heteroaryl; and
p is 0, 1, 2, 3, 4, or 5.

17. The method of claim 16, wherein at least one of the following applies:
(a) the solvent is a non-polar aprotic solvent, which is optionally selected from the group consisting of chloroform, diethyl ether, deuterated chloroform, pentane, hexanes, benzene, toluene, dichloromethane, or mixtures thereof; and
(b) the contacting is performed at room temperature.

18. (canceled)

19. (canceled)

20. A method of making the compound of claim 1, the method comprising:
contacting a compound with the structure: 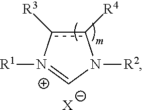
or a salt, solvate, geometric isomer, or stereoisomer thereof, with a compound of formula MX₂(A-N(H)(R⁵))₂, or a salt, solvate, geometric isomer, or stereoisomer thereof, in a solvent to form the compound of Formula I.

21. The method of claim 21, wherein at least one of the following applies:
(a) the contacting is in the presence of a base, wherein the base optionally comprises NaOC₁₋₄ alkyl, KOC₁₋₄ alkyl, lithium diisopropylamide, sodium hexamethyldisilazide, LiC₁₋₄ alkyl, or combinations thereof; and
(b) the solvent comprises a polar aprotic solvent, wherein the solvent optionally comprises tetrahydrofuran, 2-N-methylpyrrolidone, dimethyl formamide, acetonitrile, and combinations thereof.

22. (canceled)

23. (canceled)

24. (canceled)

25. A compound of Formula II, or a salt, solvate, geometric isomer, or stereoisomer thereof: 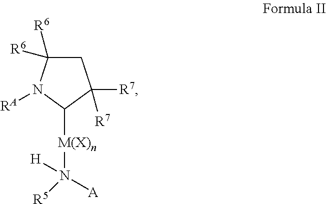
wherein:
R⁵ is H or optionally substituted C₁₋₃ alkyl;
R^{A}, R⁶ and R⁷ is independently chosen from optionally substituted C₁₋₁₂ alkyl, optionally substituted C₁₋₁₂ heteroalkyl, optionally substituted OC₁₋₁₂ alkyl, optionally substituted C₃₋₁₂ cycloalkyl, optionally substituted C₆₋₁₈ aryl, optionally substituted C₆₋₁₈ heteroaryl, or C₁₋₃ alkyl substituted with at least one aryl or heteroaryl,
wherein each optional substituent is at least one group selected from the group consisting of halogen, OR, SiR₃, OSiR₃, OSiR₃, OSi(OR)₃, BR₃, BR₂, B(OR)₃, B(OR)₂, CN, CF₃, OCF₃, SO₂R, SO₂N(R)₂, SO₃R, C(O)R, NR₂, N(R)SO₂R, N(R)SO₂N(R)₂, (CH₂)₀₋₂N(R)C(O)R, (CH₂)₀₋₂N(R)N(R)₂, N(R)C(O)OR, C₁₋₁₂ alkyl, C₁₋₁₂ heteroalkyl, OC₁₋₁₂ alkyl, C₃₋₁₂ cycloalkyl, C₆₋₁₀ aryl, and C₆₋₁₀ heteroaryl;
A is C₆₋₁₈ aryl or C₆₋₁₈ heteroaryl optionally substituted with at least one group selected from the group consisting of halogen, OR, SiR₃, OSiR₃, OSiR₃, OSi(OR)₃, BR₃, BR₂, B(OR)₃, B(OR)₂, CN, CF₃, OCF₃, SO₂R, SO₂N(R)₂, SO₃R, C(O)R, NR₂, N(R)SO₂R, N(R)SO₂N(R)₂, (CH₂)₀₋₂N(R)C(O)R, (CH₂)₀₋₂N(R)N(R)₂, N(R)C(O)OR, C₁₋₁₂ alkyl, C₁₋₁₂ heteroalkyl, OC₁₋₁₂ alkyl, C₃₋₁₂ cycloalkyl, C₆₋₁₀ aryl, and C₆₋₁₀ heteroaryl;
M is a transition metal;
X is a counter anion;
n is an integer from 1 to 4; and
R is independently at each occurrence hydrogen or optionally substituted C₁₋₁₀ alkyl.

26. A compound of Formula III, or a salt, solvate, geometric isomer, or stereoisomer thereof: 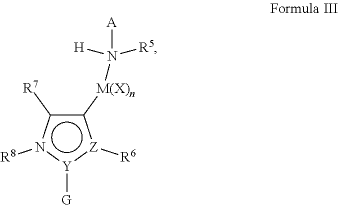
wherein:
R⁵ is H or C₁₋₃ alkyl;
R⁶, R⁷ and R⁸ is independently chosen from optionally substituted C₁₋₁₂ alkyl, optionally substituted C₁₋₁₂ heteroalkyl, optionally substituted OC₁₋₁₂ alkyl, optionally substituted C₃₋₁₂ cycloalkyl, optionally substituted C₆₋₁₈ aryl, optionally substituted C₆₋₁₈ heteroaryl, or C₁₋₃ alkyl substituted with at least one aryl or heteroaryl,
wherein each optional substituent is at least one group selected from the group consisting of halogen, OR, SiR₃, OSiR₃, OSiR₃, OSi(OR)₃, BR₃, BR₂, B(OR)₃, B(OR)₂, CN, CF₃, OCF₃, SO₂R, SO₂N(R)₂, SO₃R, C(O)R, NR₂, N(R)SO₂R, N(R)SO₂N(R)₂, (CH₂)₀₋₂N(R)C(O)R, (CH₂)₀₋₂N(R)N(R)₂, N(R)C(O)OR, C₁₋₁₂ alkyl, C₁₋₁₂ heteroalkyl, OC₁₋₁₂ alkyl, C₃₋₁₂ cycloalkyl, C₆₋₁₀ aryl, and C₆₋₁₀ heteroaryl;
A is C₆₋₁₈ aryl or C₆₋₁₈ heteroaryl optionally substituted with at least one group selected from the group consisting of halogen, OR, SiR₃, OSiR₃, OSiR₃, OSi(OR)₃, BR₃, BR₂, B(OR)₃, B(OR)₂, CN, CF₃, OCF₃, SO₂R, SO₂N(R)₂, SO₃R, C(O)R, NR₂, N(R)SO₂R, N(R)SO₂N(R)₂, (CH₂)₀₋₂N(R)C(O)R, (CH₂)₀₋₂N(R)N(R)₂, N(R)C(O)OR, C₁₋₁₂ alkyl, C₁₋₁₂ heteroalkyl, OC₁₋₁₂ alkyl, C₃₋₁₂ cycloalkyl, C₆₋₁₀ aryl, and C₆₋₁₀ heteroaryl;
G is absent, optionally substituted C₁₋₁₂ alkyl, optionally substituted C₁₋₁₂ heteroalkyl, optionally substituted OC₁₋₁₂ alkyl, optionally substituted C₃₋₁₂ cycloalkyl, optionally substituted C₆₋₁₈ aryl, optionally substituted C₆₋₁₈ heteroaryl, or C₁₋₃ alkyl substituted with at least one aryl or heteroaryl, wherein the optional substitution is by at least one group selected from the group consisting of halogen, OR, SiR₃, OSiR₃, OSiR₃, OSi(OR)₃, BR₃, BR₂, B(OR)₃, B(OR)₂, CN, CF₃, OCF₃, SO₂R, SO₂N(R)₂, SO₃R, C(O)R, NR₂, N(R)SO₂R, N(R)SO₂N(R)₂, (CH₂)₀₋₂N(R)C(O)R, (CH₂)₀₋₂N(R)N(R)₂, N(R)C(O)OR, C₁₋₁₂ alkyl, C₁₋₁₂ heteroalkyl, OC₁₋₁₂ alkyl, C₃₋₁₂ cycloalkyl, C₆₋₁₀ aryl, and C₆₋₁₀ heteroaryl;
M is a transition metal;
X is a counter anion;
Y is N or C;
Z is N or C;
n is an integer from 1 to 4; and
R is independently at each occurrence hydrogen or optionally substituted C₁₋₁₀ alkyl; with the proviso that Y and Z are not both C.
